(19) United States
(12) Patent Application Publication
(10) Pub. No.: US 2018/0105729 A1
(43) Pub. Date: Apr. 19, 2018

(54) WINTERIZING COMPOSITIONS FOR SULFUR SCAVENGERS AND METHODS FOR MAKING AND USING SAME

(71) Applicant: Lubrizol Oilfield Solutions, Inc., WIckliffe, OH (US)

(72) Inventors: John Hamilton, Calgary (CA); Thomas P. Wilson, Jr., Floresville, TX (US); Mark Wanner, Aliquippa, PA (US); Jacob Marcotte, Houston, TX (US); Brian Snodgrass, Edmonton (CA)

(21) Appl. No.: 15/556,688

(22) PCT Filed: Mar. 10, 2016
(86) PCT No.: PCT/US2016/021739

§ 371 Date: Sep. 8, 2017

Related U.S. Application Data
(60) Provisional application No. 62/130,898, filed on Mar. 10, 2015.

(51) Int. Cl. C09K 8/035; C09K 8/532

(52) U.S. Cl. CPC C09K 8/035; C09K 2208/20; C09K 8/532

(57) ABSTRACT

Winterizing composition include a sulfur scavenger solution and a winterizing composition including at least one triol with or without a secondary winterizing agents, where the winterizing solution provided that the properties of the winterizing compositions have desired values including pour point temperatures at or below −40° C. and low evaporation rates at temperatures between about 35° C. and 60° C.

### BACKGROUND OF THE INVENTION

### Field of the Invention

This invention relates to winterizing compositions for sulfur scavengers, winterized sulfur scavenger compositions and methods for making and using same.

More particularly, this invention relates to winterizing compositions for sulfur scavengers, winterized sulfur scavenger compositions and methods for making and using same, where the winterizing compositions including at least one triol and the winterized compositions includes at least one sulfur scavenger and a wintering agent including at least one triol.

### Description of the Related Art

Sulfur scavengers are widely used to remove hydrogen sulfide (H₂S) or other noxious sulfur-containing species from fluid produced from gas and/or oil well. Many applications require the compositions including sulfur scavenger compositions to remain as a liquid at temperatures down to −40° C. (−40° F.). The most commonly used winterizing material for sulfur scavenger compositions is methanol. Under higher temperature applications (above 35° C.), methanol is unsuitable because of its high rate of evaporation, and other more expensive winterizing materials such as glycols are used.

Thus, there is a need in the art for alternatives to glycols for winterizing sulfur scavenger compositions that are subjected to temperatures above about 35° C., but maintain their low temperature properties. The present invention demonstrates that winterizing compositions including triols are suitable alternatives to methanol and glycols.

### SUMMARY OF THE INVENTION

Embodiments of this invention provide winterizing compositions including a sulfur scavenger solution including at least one sulfur scavenger, and a winterizing solution including at least one triol, where the winterizing solution lowers a pour point of the sulfur scavenging composition to a temperature of or below −40° C. and reduces an evaporation rate of the sulfur scavenging composition at temperatures between 35° C. and 60° C. In other embodiments, the evaporation rate is reduced at temperatures between 40° C. and 60° C. In other embodiments, the evaporation rate is reduced at temperatures between 45° C. and 60° C. In other embodiments, the evaporation rate is reduced at temperatures between 50° C. and 60° C. In other embodiments, the sulfur scavenger solution includes only triazine sulfur scavengers. In other embodiments, the sulfur scavenger solution includes triazine and non-triazine sulfur scavengers. In other embodiments, the sulfur scavenger solution includes only non-triazine sulfur scavengers.

Embodiments of this invention provide methods of providing freeze protection for a sulfur scavenger composition comprising blending a sulfur scavenger solution including at least one sulfur scavenger and a winterizing solution including at least one triol, where the winterizing solution lowers a pour point of the sulfur scavenging composition to a temperature of or below −40° C. and reduces an evaporation rate of the sulfur scavenging composition at temperatures between 35° C. and 60° C. In other embodiments, the evaporation rate is reduced at temperatures between 40° C. and 60° C. In other embodiments, the evaporation rate is reduced at temperatures between 45° C. and 60° C. In other embodiments, the evaporation rate is reduced at temperatures between 50° C. and 60° C. In other embodiments, the sulfur scavenger solution includes only triazine sulfur scavengers. In other embodiments, the sulfur scavenger solution includes triazine and non-triazine sulfur scavengers. In other embodiments, the sulfur scavenger solution includes only non-triazine sulfur scavengers.

Embodiments of this invention provide methods of reducing noxious sulfur species in a hydrocarbon stream, which comprises contacting the hydrocarbon stream with an effective amount of a sulfur scavenging composition comprising at least one sulfur scavenger and a winterizing solution including in at least one triol, where the winterizing solution lowers a pour point of the sulfur scavenging composition to a temperature of or below −40° C. and reduces an evaporation rate of the sulfur scavenging composition at temperatures between 35° C. and 60° C. In other embodiments, the evaporation rate is reduced at temperatures between 40° C. and 60° C. In other embodiments, the evaporation rate is reduced at temperatures between 45° C. and 60° C. In other embodiments, the evaporation rate is reduced at temperatures between 50° C. and 60° C. In other embodiments, the sulfur scavenger solution includes only triazine sulfur scavengers. In other embodiments, the sulfur scavenger solution includes triazine and non-triazine sulfur scavengers. In other embodiments, the sulfur scavenger solution includes only non-triazine sulfur scavengers.

### BRIEF DESCRIPTION OF THE DRAWINGS

The invention can be better understood with reference to the following detailed description together with the appended illustrative drawings in which like elements are numbered the same:

FIG. 1 depicts the evaporation rates of different BS1 winterizing compositions.

FIG. 2 depicts the percent mass loss of the BS1 winterizing agents of FIG. 1 at 60° F. and 42% active sulfur scavengers.

FIG. 3 depicts the evaporation rate of different BSs winterizing compositions.

FIG. 4 depicts the percent mass loss of the BS2 winterizing agents of FIG. 3 at 60° F. and 42% active sulfur scavengers.

FIG. 5 depicts the evaporation rate of different BS3 winterizing compositions.

FIG. 6 depicts the percent mass loss of the BS3 winterizing agents of FIG. 5 at 60° F. and 42% active sulfur scavengers.

FIG. 7 depicts the evaporation rate of different BS3 winterizing compositions toll manufactured.

FIG. 8 depicts the percent mass loss of the BS3 winterizing agents of FIG. 7 at 60° F. and 42% active sulfur scavengers.

FIG. 9-12 depict IR spectra of V1, V1.1, V13, and V13.7.

FIG. 13 depicts H₂S uptake data for V1, V2.2, V4, V5.1, V6.1, and V7.3.

FIG. 14 depicts viscosity data for V1, V2.2, V4, V5.1, V6.1, and V7.3.

FIG. 15 depicts H₂S uptake data for V1, V1.1, V13, V13.7, and SC8411HC.

FIG. 16 depicts average blend viscosities at temperatures between −5° C. and 50° C.

FIG. 17 depicts average Blend 17 vs. BS1 (42 wt. %) blends and SC8440TM viscosities at temperatures between −5° C. and 50° C.

FIG. 18 depicts average 40 wt. % blend viscosities at temperatures between −5° C. and 50° C.

FIG. 19 depicts average 36 wt. % blend viscosities at temperatures between −5° C. and 50° C.

### DEFINITIONS USED IN THE INVENTION

The term “substantially” means that the property is within 80% of its desired value. In other embodiments, “substantially” means that the property is within 90% of its desired value. In other embodiments, “substantially” means that the property is within 95% of its desired value. In other embodiments, “substantially” means that the property is within 99% of its desired value. For example, the term “substantially complete” as it relates to a coating, means that the coating is at least 80% complete. In other embodiments, the term “substantially complete” as it relates to a coating, means that the coating is at least 90% complete. In other embodiments, the term “substantially complete” as it relates to a coating, means that the coating is at least 95% complete. In other embodiments, the term “substantially complete” as it relates to a coating, means that the coating is at least 99% complete.

The term “substantially” means that a value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

The term “about” means that the value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

The term “drilling fluids” refers to any fluid that is used during well drilling operations including oil and/or gas wells, geo-thermal wells, water wells or other similar wells.

An over-balanced drilling fluid means a drilling fluid having a circulating hydrostatic density (pressure) that is greater than the formation density (pressure).

An under-balanced and/or managed pressure drilling fluid means a drilling fluid having a circulating hydrostatic density (pressure) lower or equal to a formation density (pressure). For example, if a known formation at 10,000 ft (True Vertical Depth—TVD) has a hydrostatic pressure of 5,000 psi or 9.6 lbm/gal, an under-balanced drilling fluid would have a hydrostatic pressure less than or equal to 9.6 lbm/gal. Most under-balanced and/or managed pressure drilling fluids include at least a density reduction additive. Other additives may be included such as corrosion inhibitors, pH modifiers and/or a shale inhibitors.

The terms “glycerol”, “glycerine” and “glycerin” may be used interchangeably in the specification and represent 1,2,3-trihydroxypropane.

The term “mole ratio” or “molar ratio” means a ratio based on relative moles of each material or compound in the ratio.

The term “weight ratio” means a ratio based on relative weight of each material or compound in the ratio.

The term “volume ratio” means a ratio based on relative volume of each material or compound in the ratio.

The term “mole %” means mole percent.

The term “vol. %” means volume percent.

The term “wt. %” means weight percent.

The term “SG” means specific gravity.

The term “gpt” means gallons per thousand gallons.

The term “ppt” means pounds per thousand gallons.

The term “ppg” means pounds per gallon.

The term “MMscfd” means million standard cubic feet per day.

The term “ppm” means parts per million.

The term “lpd” means pounds per day.

### DETAILED DESCRIPTION OF THE INVENTION

The inventors have found that winterizing compositions for use in sulfur scavenger composition comprises of sulfur scavengers, especially scavenging compositions including triazine type sulfur scavengers, can be formulated including a triol, a mixture of triols, a mixture of triols and water, or a mixture of a triol, water, and a secondary winterizing agent. The inventors have also found that triol winterizing agents may be formulated from low cost crude triol products to yield winterizing compositions competitive with glycols based on performance as well as cost.

A problem exists with current industry freeze protected triazine based scavenger solutions when operating between 40° C. and 60° C. In this temperature range, many of the winterizing agents used to lower a pour point of the scavenger solutions evaporate causing the reacted scavenger solutions to become highly viscous and difficult to handle. The inventors have found that a 42% active sulfur scavenger containing solutions may be formulated that are freeze protected to temperatures at or below −40° C. (−40° F.) and have low evaporation rates at temperatures between 35° C. and 60° C., which reduce or prevent the scavenger solutions from developing an unworkable viscosity, or alternatively, which will maintain a workable viscosity of the scavenger solutions. In certain embodiments, the evaporation rate of the compositions at 50° C. is between about 0.05 grams/hour (g/hr) and about 0.4 g/hr. In other embodiments, the evaporation rate of the compositions at 50° C. is between about 0.1 grams/hour (g/hr) and about 0.35 g/hr. In other embodiments, the evaporation rate of the compositions at 50° C. is between about 0.1 grams/hour (g/hr) and about 0.3 g/hr. In other embodiments, the evaporation rate of the compositions at 60° C. is between about 0.1 grams/hour (g/hr) and about 0.5 g/hr. In other embodiments, the evaporation rate of the compositions at 60° C. is between about 0.2 grams/hour (g/hr) and about 0.5 g/hr. In other embodiments, the evaporation rate of the compositions at 60° C. is between about 0.2 grams/hour (g/hr) and about 0.45 g/hr. In other embodiments, the evaporation rate of the compositions at 60° C. is between about 0.2 grams/hour (g/hr) and about 0.4 g/hr.

Embodiments of this invention broadly relate to winterizing compositions including a sulfur scavenger solution including at least one sulfur scavenger, and a winterizing solution including at least one triol. In certain embodiments, the triol comprises glycerin. In other embodiments, the glycerin comprises a crude glycerin, a blend of glycerin and water. In other embodiments, the winterizing solution includes blends of crude glycerin and a secondary winterizing agent selected from the group consisting of glycols, alcohols, glymes, glycerols, non-ionic surfactants, dioxolane, and mixtures or combinations thereof. In certain embodiments, the blends include a first amount of crude glycerin and a second amount of a secondary winterizing agent. In other embodiments, the blends of crude glycerin and ethylene glycol includes from 99 wt. % to 15 wt. % of crude glycerin and from 1 wt % to 85 wt. % of ethylene glycol. In other embodiments, the blends of crude glycerin and triethylene glycol includes from 99 wt. % to 65 wt. % of crude glycerin and from 1 wt. % to 35 wt. % of triethylene glycol. In other embodiments, the blends of crude glycerin and ethylene glycol monobutylether includes from 99 wt. % to 50 wt % of crude glycerin and from 1 wt. % to 50 wt. % of ethylene glycol monobutylether. In other embodiments, the blends of crude glycerin and polypropylene glycol 425MW includes from 99 wt. % to 85 wt. % of crude glycerin and from 1 wt. % to 15 wt. % of polypropylene glycol 425MW. In other embodiments, the blends of crude glycerin and glycol ether DPM includes from 99 wt. % to 70 wt. % of crude glycerin and from 1 wt. % to 30 wt. % of glycol ether DPM. In other embodiments, the blends of crude glycerin and propylene glycol includes from 99 wt. % to 45 wt. % of crude glycerin and from 1 wt. % to 55 wt. % of propylene glycol. In other embodiments, the blends of crude glycerin and RhodiaSolv MSOL includes from 99 wt. % to 80 wt. % of crude glycerin and from 1 wt. % to 20 wt. % of RhodiaSolv MSOL. In other embodiments, the blends of crude glycerin and of glycerin includes from 99 wt. % to 1 wt. % of crude glycerin and from 1 wt. % to 99 wt. % of glycerin. In other embodiments, the blends of crude glycerin and of Ecosurf EH-14 includes from 99 wt. % to 70 wt. % of crude glycerin and from 1 wt. % to 30 wt. % Ecosurf EH-14. In other embodiments, the blends of crude glycerin and Tergitol 15-S-12 includes from 99 wt. % to 75 wt. % of crude glycerin and from 1 wt. % to 25 wt. % of Tergitol 15-S-12. In other embodiments, the blends of crude glycerin and TERGITOL™ NP-15 (nonylphenol ethoxylate surfactant) includes 99 wt. % to 70 wt. % of crude glycerin and from 1 wt. % to 30 wt. % of TERGITOL™ NP-15. In other embodiments, the blends of crude glycerin and polyglyme includes from 99 wt. % to 95 wt. % of crude glycerin and from 1 wt. % to 5 wt. % of polyglyme. In other embodiments, the blends of crude glycerin and dioxolane includes from 99 wt. % to 90 wt. % of crude glycerin and from 1 wt. % to 10 wt. % of dioxolane. In other embodiments, the blends of crude glycerin and diethylene glycol monobutylether includes from of 99 wt. % to 55 wt. % of crude glycerin and from 1 wt. % to 45 wt. % of diethylene glycol monobutylether. In other embodiments, the blends of crude glycerin and diethylene glycol includes from 99 wt. % to 55 wt. % of crude glycerin and from 1 wt. % to 45 wt. % of diethylene glycol. In other embodiments, the blends of crude glycerin and ethylene glycol includes from 99 wt. % of to 10 wt. % of crude glycerin and from 1 wt. % of to 90 wt. % of ethylene glycol. In other embodiments, the blends of crude glycerin and triethylene glycol includes from 99 wt. % of to 40 wt. % of crude glycerin and from 1 wt % of to 60 wt. % of griethylene glycol. In other embodiments, the blends of crude glycerin and ethylene glycol monobutylether includes from 99 wt. % of to 15 wt. % of crude glycerin and from 1 wt. % of to 85 wt. % of ethylene glycol monobutylether. In other embodiments, the blends of crude glycerin and polypropylene glycol 425MW includes from 99 wt. % of to 70 wt. % of crude glycerin and from 1 wt. % of to 30 wt. % of polypropylene glycol 425MW. In other embodiments, the blends of crude glycerin and glycol ether DPM includes from 99 wt. % of to 50 wt % of crude glycerin and from 1 wt. % of to 50 wt. % of glycol ether DPM. In other embodiments, the blends of crude glycerin and propylene glycol includes from 99 wt. % of to 1 wt. % of crude glycerin and from 1 wt. % of to 99 wt. % of propylene glycol. In other embodiments, the blends of crude glycerin and RhodiaSolv MSOL includes from 99 wt. % of to 65 wt. % of crude glycerin and from 1 wt. % of to 35 wt. % of RhodiaSolv MSOL. In other embodiments, the blends of crude glycerin and glycerin includes from 99 wt. % of to 1 wt. % of crude glycerin and from 1 wt. % of to 99 wt. % of glycerin. In other embodiments, the blends of crude glycerin and Ecosurf EH-14 includes from 99 wt. % of to 50 wt. % of crude glycerin and from 1 wt. % of to 50 wt. % of Ecosurf EH-14. In other embodiments, the blends of crude glycerin and Tergitol 15-S-12 includes from 99 wt. % of to 60 wt. % of crude glycerin and from 1 wt. % of to 40 wt. % of Tergitol 15-S-12. In other embodiments, the blends of crude glycerin and TERGITOL™ NP-15 (Nonylphenol Ethoxylate surfactant) includes from 99 wt. % of to 50 wt. % of crude glycerin and from 1 wt. % of to 50 wt. % of TERGITOL™ NP-15. In other embodiments, the blends of crude glycerin and polyglyme includes from 99 wt. % of to 90 wt. % of crude glycerin and from 1 wt. % of to 10 wt. % of polyglyme. In other embodiments, the blends of crude glycerin and dioxolane includes from 99 wt. % of to 80 wt. % of crude glycerin and from 1 wt. % of to 20 wt. % of dioxolane. In other embodiments, the blends of crude glycerin and diethylene glycol monobutylether includes from 99 wt % of to 25 wt. % of crude glycerin and from 1 wt. % of to 75 wt. % of diethylene glycol monobutylether. In other embodiments, the blends of crude glycerin and diethylene glycol includes from 99 wt. % of to 10 wt. % of crude glycerin and from 1 wt. % of to 90 wt. % of diethylene glycol. In other embodiments, the blends of crude glycerin and ethylene glycol includes from 1 wt. % of to 99 wt. % of crude glycerin and from 1 wt. % of to 90 wt. % of ethylene glycol. In other embodiments, the blends of crude glycerin and triethylene glycol includes from wt. % of to 15 wt. % of crude glycerin and from 1 wt. % of to 85 wt. % of triethylene glycol. In other embodiments, the blends of crude glycerin and ethylene glycol monobutylether includes from 99 wt. % of to 1 wt. % of crude glycerin and from 1 wt. % of to 99 wt. % of ethylene glycol monobutylether. In other embodiments, the blends of crude glycerin and polypropylene glycol 425MW includes from 99 wt. % of to 60 wt. % of crude glycerin and from 1 wt % of to 40 wt. % of polypropylene glycol 425MW. In other embodiments, the blends of crude glycerin and glycol ether DPM includes from 99 wt. % of to 30 wt. % of crude glycerin and from 1 wt. % of to 70 wt. % of glycol ether DPM. In other embodiments, the blends of crude glycerin and propylene glycol includes from 99 wt. % of to 1 wt. % of crude glycerin and from 1 wt. % of to 99 wt. % of propylene glycol. In other embodiments, the blends of crude glycerin and RhodiaSolv MSOL includes from 99 wt. % of to 50 wt. % of crude glycerin and from 1 wt. % of to 50 wt. % of RhodiaSolv MSOL. In other embodiments, the blends of crude glycerin and glycerin includes from 99 wt. % of to 1 wt. % of crude glycerin and from 1 wt. % of to 99 wt. % of glycerin. In other embodiments, the blends of crude glycerin and Ecosurf EH-14 includes from 99 wt. % of to 30 wt. % of crude glycerin and from 1 wt. % of to 70 wt. % of Ecosurf EH-14. In other embodiments, the blends of crude glycerin and Tergitol 15-S-12 includes from 99 wt. % of to 40 wt. % of crude glycerin and from 1 wt. % of to 60 wt. % of Tergitol 15-S-12. In other embodiments, the blends of crude glycerin and TERGITOL™ NP-15 (Nonylphenol Ethoxylate surfactant) includes from 99 wt. % of to 25 wt. % of crude glycerin and from 1 wt. % of to 75 wt. % of TERGITOL™ NP-15. In other embodiments, the blends of crude glycerin and polyglyme includes from 99 wt. % of to 80 wt. % of crude glycerin and from 1 wt. % of to 20 wt. % of polyglyme. In other embodiments, the blends of crude glycerin and dioxolane includes from 99 wt. % of to 60 wt. % of crude glycerin and from 1 wt. % of to 40 wt. % of dioxolane. In other embodiments, the blends of crude glycerin and diethylene glycol monobutylether includes from 99 wt. % of to 1 wt. % of crude glycerin and from 1 wt. % of to 99 wt. % of diethylene glycol monobutylether. In other embodiments, the blends of crude glycerin and diethylene glycol includes from 99 wt. % of to 1 wt. % of crude glycerin and from 1 wt. % of to 99 wt. % of diethylene glycol. In certain embodiments, the sulfur scavenger solution includes only triazine sulfur scavengers. In other embodiments, the sulfur scavenger solution includes triazine and non-triazine sulfur scavengers. In other embodiments, the sulfur scavenger solution includes only non-triazine sulfur scavengers. In other embodiments, the triazine sulfur scavenger is a reaction product of an aldehyde with a primary amine. In other embodiments, the triazine sulfur scavengers are s-triazines of the general formula:

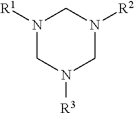

where R¹⁻³ are independently a hydrocarbyl group having between 1 and 40 carbon atoms, where one or more of the carbon atoms may be replace by oxygen atoms. In other embodiments, the triazine sulfur scavengers are selected from the group consisting of 1,3,5-triazine-1,3,5(2H,4H,6H)-triethanol, 2,2′,2″-(hexahydro-1,3,5-triazine-1,3,5-triyl)triethanol, hexahydro-1,3,5-tris(2-hydroxyethyl)-1,3,5-triazine, 1,3,5-tris(2-hydroxyethyl)-1,3,5-triazacyclohexane, 1,3,5-tris(2-hydroxyethyl)hexahydro-1,3,5-triazine, 1,3,5-tris(2-hydroxyethyl)hexahydro-s-triazine, hexahydro-1,3,5-tris(2-hydroxyethyl)-s-triazine, hexahydro-1,3,5-tris(hydroxyethyl)triazine, N,N′,N″-tris(2-hydroxyethyl)hexahydro-s-triazine, s-triazine-1,3,5(2H,4H,6H)-triethanol (CAS No. 203-612-8), 1,3,5-Triazine, hexahydro-1,3,5-trimethyl, hexahydro-1,3,5-trimethyl-1,3,5-triazine, 1,3,5-trimethyl-1,3,5-triazacyclohexane, 1,3,5-trimethylhexahydro-1,3,5-triazinem, 1,3,5-trimethylhexahydro-s-triazine, 1,3,5-trimethyltrimethylenetriamine, N,N′,N″-trimethyl-1,3,5-triazacyclohexane, hexahydro-1,3,5-trimethyl-s-triazine, and mixtures or combinations thereof. In other embodiments, the composition contains from 10 wt. % to 90 wt % net triazine, or from 20 wt. % to 80 wt. % net triazine, or from 30 wt. % to 70 wt. % net triazine or from 35 wt. % to 65 wt. % net triazine or from 40 wt. % to 50 wt. %. net triazine of 40 wt. % to 45 wt. % net triazine. In other embodiments, further includes a performance improving additive composition.

Embodiments of this invention broadly relate to methods of providing freeze protection for a sulfur scavenger composition comprising blending a sulfur scavenger solution including at least one sulfur scavenger and a winterizing solution including at least one triol.

Embodiments of this invention broadly relate to methods of reducing noxious sulfur species in a hydrocarbon stream, which comprises contacting the hydrocarbon stream with an effective amount of a triazine sulfur scavenging composition comprising at least one sulfur scavenger and a winterizing solution including in at least one triol, where the winterizing solution lowers a pour point of the sulfur scavenging composition to a temperature of or below −40° C. and reduces an evaporation rate of the triazine sulfur scavenging composition at temperatures between 50° C. and 60° C. In certain embodiments, the hydrocarbon stream comprises at least one hydrocarbon containing steam, produced water containing stream, other downhole stream, or hydrocarbon containing stream transported in a pipeline or flow line. In other embodiments, the hydrocarbon stream is contacted with the sulfur scavenging composition in a bubble tower or a pipeline. In other embodiments, the effective amount of the triazine sulfur scavenging composition is determined according to the formula:

EA=X*GP*C_{H2S}

wherein EA is the effective amount in liters per day (lpd), X is a multiplier of from about 0.1 to about 0.5, or 0.2 to about 0.4, or 0.25 to 0.35, or 0.3, GP is the amount of hydrocarbon stream treated in million standard cubic feet per day (MMscfd), and C_{H2S} is the concentration of H₂S in parts per million (ppm). In other embodiments, EA ranges from 250 lpd to 2,500 lpd, when X=0.1, GP=100 MMscfd, and C_{H2S}=25 ppm to 250 ppm. In other embodiments, EA ranges from 750 lpd to 7,500 lpd, when X=0.3, GP=100 MMscfd, and C_{H2S}=25 ppm to 250 ppm. In other embodiments, EA ranges from 1,500 lpd to 15,000 lpd, when X=0.3, GP=200 MMscfd, and C_{H2S}=25 ppm to 250 ppm. In other embodiments, EA ranges from 2,250 lpd to 22,500 lpd, when X=0.3, GP=300 MMscfd, and C_{H2S}=25 ppm to 250 ppm. In other embodiments, EA ranges from 3,000 lpd to 30,000 lpd, when X=0.3, GP=400 MMscfd, and C_{H2S}=25 ppm to 250 ppm. In other embodiments, EA ranges from 3,750 lpd to 37,500 lpd, when X=0.3, GP=500 MMscfd, and C_{H2S}=25 ppm to 250 ppm. In other embodiments, EA ranges from 4,500 lpd to 45,000 lpd, when X=0.3, GP=600 MMscfd, and C_{H2S}=25 ppm to 250 ppm. In other embodiments, EA ranges from 5,250 lpd to 52,500 lpd, when X=0.3, GP=700 MMscfd, and C_{H2S}=25 ppm to 250 ppm. In other embodiments, EA ranges from 6,000 lpd to 60,000 lpd, when X=0.3, GP=800 MMscfd, and C_{H2S}=25 ppm to 250 ppm. In other embodiments, EA ranges from 6,750 lpd to 67,500 lpd, when X=0.3, GP=900 MMscfd, and C_{H2S}=25 ppm to 250 ppm. In other embodiments, EA ranges from 7,500 lpd to 75,000 lpd, when X=0.3, GP=1000 MMscfd, and C_{H2S}=25 ppm to 250 ppm. In other embodiments, the hydrocarbon-containing stream comprises a natural gas containing stream, an crude oil containing stream, a stream including both natural gas and crude oil, a kerosene containing stream, a fuel oil containing stream, a heating oil containing stream, a distillate fuel containing stream, a bunker fuel oil containing stream, or mixtures and combinations thereof.

### DISCUSSION

The best way to discuss how evaporation rates are changed is by looking at the phenomenon called boiling point elevation. Equation 1 below can help explain the boiling point elevation when a solute is dissolved in a pure solvent. The scavenger solution being tested in this request is not a pure solvent because it contains triazine and water, but the principal is still helpful to explain the behavior.

ΔT=iK_{b}m (1)

The variable ΔT is the change in temperature, i (the van't Hoff factor) is the number of particles formed by the solute when in solution, K_{b} is the ebullioscopic constant of the solvent, and m is the molality concentration of the solute in the solution (Zumdahl and Zumdahl 505). The molal concentration can be calculated using Equation 2.

$$m = \frac{moles of solute}{mass of solvent ( kg )} \qquad ( 2 )$$

Equation 2 helps to explain why boiling point elevation is a colligative property (Zumdahl and Zumdahl 486). Colligative properties are dependent on the number of solute particles dissolved in a solvent (Zumdahl and Zumdahl 504). Hence, in some versions, the solutes were added to the highest concentration possible. In this request the solutes will refer to the chemicals added to the base solution.

This application would like to see ΔT increase as much as possible. The ways to do this would be to increase the van′t Hoff factor and the molality. The van′t Hoff factor can be increased by selecting a solute that splits apart when in solution (a salt). This route of adding a salt into the scavenger was avoided because scavenger solutions can already have scaling problems in the field. This leaves the only option to increase the molality of the solution.

Increasing the molality of the solution can happen two ways, one by increasing the moles of solute and the other by decreasing the mass of the solvent. In this application, water is the solvent. This request manipulated both of these values in order to have the highest boiling point possible. Some versions added the most amount of solute until reaching 42% activity while others added only enough solute to freeze protect the solution. Additionally, other versions decreased the mass of the solvent by starting with a different base solution that contained less water.

### Suitable Reagents for Use in the Invention

### Sulfur Scavengers

Suitable sulfur scavengers for use in this invention include, without limitation, amines, aldehyde-amine adducts, triazines, or the like or mixtures or combinations thereof. Exemplary examples of aldehyde-amine adduct type sulfur scavengers include, without limitation, (1) formaldehyde reaction products with primary amines, secondary amines, tertiary amines, primary diamines, secondary diamines, tertiary diamines, mixed diamines (diamines having mixtures of primary, secondary and tertiary amines), primary polyamines, secondary polyamines, tertiary polyamines, mixed polyamines (polyamines having mixtures of primary, secondary and tertiary amines), monoalkanolamines, dialkanol amines and trialkanol amines; (2) linear or branched alkanal (i.e., RCHO, where R is a linear or branched alkyl group having between about 1 and about 40 carbon atoms or mixtures of carbon atoms and heteroatoms such as 0 and/or N) reaction products with primary amines, secondary amines, tertiary amines, primary diamines, secondary diamines, tertiary diamines, mixed diamines (diamines having mixtures of primary, secondary and tertiary amines), primary polyamines, secondary polyamines, tertiary polyamines, mixed polyamines (polyamines having mixtures of primary, secondary and tertiary amines), monoalkanolamines, dialkanol amines and trialkanol amines; (3) aranals (R′CHO, where R′ is an aryl group having between about 5 and about 40 carbon atoms and heteroatoms such as O and/or N) reaction products with primary amines, secondary amines, tertiary amines, primary diamines, secondary diamines, tertiary diamines, mixed diamines (diamines having mixtures of primary, secondary and tertiary amines), primary polyamines, secondary polyamines, tertiary polyamines, mixed polyamines (polyamines having mixtures of primary, secondary and tertiary amines), monoalkanolamines, dialkanol amines and trialkanol amines; (4) alkaranals (R″CHO, where R″ is an alkylated aryl group having between about 6 and about 60 carbon atoms and heteroatoms such as 0 and/or N) reaction products with primary amines, secondary amines, tertiary amines, primary diamines, secondary diamines, tertiary diamines, mixed diamines (diamines having mixtures of primary, secondary and tertiary amines), primary polyamines, secondary polyamines, tertiary polyamines, mixed polyamines (polyamines having mixtures of primary, secondary and tertiary amines), monoalkanolamines, dialkanol amines and trialkanol amines; (5) aralkanals (R′″CHO, where R′″ is an aryl substituted linear or branched alkyl group having between about 6 and about 60 carbon atoms and heteroatoms such as 0 and/or N) reaction products with primary amines, secondary amines, tertiary amines, primary diamines, secondary diamines, tertiary diamines, mixed diamines (diamines having mixtures of primary, secondary and tertiary amines), primary polyamines, secondary polyamines, tertiary polyamines, mixed polyamines (polyamines having mixtures of primary, secondary and tertiary amines), monoalkanolamines, dialkanol amines and trialkanol amines, and (6) mixtures or combinations thereof. It should be recognized that under certain reaction conditions, the reaction mixture may include triazines in minor amount or as substantially the only reaction product (greater than 90 wt. % of the product), while under other conditions the reaction product can be monomeric, oligomeric, polymeric, or mixtures or combinations thereof. Other sulfur scavengers are disclosed in WO04/043038, US2003-0089641, GB2397306, U.S. patent application Ser. Nos. 10/754,487, 10/839,734, and 10/734,600, incorporated herein by reference.

### Triazine Sulfur Scavengers

Suitable sulfur scavengers for use in the present invention include, without limitation, s-triazines of the general formula:

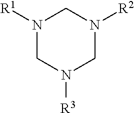

where R¹⁻³ are independently a hydrocarbyl group having between 1 and 40 carbon atoms, where one or more of the carbon atoms may be replace by oxygen atoms. Exemplary examples of s-triazines include, without limitation, 1,3,5-triazine-1,3,5(2H,4H,6H)-triethanol, 2,2′,2″-(hexahydro-1,3,5-triazine-1,3,5-triyl)triethanol, hexahydro-1,3,5-tris(2-hydroxyethyl)-1,3,5-triazine, 1,3,5-tris(2-hydroxyethyl)-1,3,5-triazacyclohexane, 1,3,5-tris(2-hydroxyethyl)hexahydro-1,3,5-triazine, 1,3,5-tris(2-hydroxyethyl)hexahydro-s-triazine, hexahydro-1,3,5-tris(2-hydroxyethyl)-s-triazine, hexahydro-1,3,5-tris(hydroxyethyl)triazine, N,N,N″-tris(2-hydroxyethyl)hexahydro-s-triazine, s-triazine-1,3,5(2H,4H,6H)-triethanol (CAS No. 203-612-8), 1,3,5-Triazine, hexahydro-1,3,5-trimethyl, hexahydro-1,3,5-trimethyl-1,3,5-triazine, 1,3,5-trimethyl-1,3,5-triazacyclohexane, 1,3,5-trimethylhexahydro-1,3,5-triazinem, 1,3,5-trimethylhexahydro-s-triazine, 1,3,5-trimethyltrimethylenetriamine, N,N′,N″-trimethyl-1,3,5-triazacyclohexane, hexahydro-1,3,5-trimethyl-s-triazine, and mixtures or combinations thereof.

### Triol Winterizing Agents

Suitable triol winterizing agents for use in the present invention include, without limitation, triols having between 3 and 20 carbon atoms, where one or more of the carbon atoms may be replaced by oxygen atoms and where the triols may be linear, branched, cyclic or aromatic. Exemplary triols include, without limitation, glycerine (1,2,3-trihydroxypropane), trihydroxybutanes, trihydroxypentanes, trihydroxyhexanes, higher alkane triols, trihydroxybenznes, trihydroxy alkyl benzenes, and mixtures or combinations thereof. Exemplary trihydroxybutanes include 1,2,3-trihydroxybutane, 1,2,4-trihydroxybutane, and mixtures or combinations thereof. Exemplary trihydroxypentanes include 1,2,3-trihydroxypentane, 1,2,4-trihydroxypentane, 1,2,5-trihydroxypentane, 2,3,4-trihydroxypentane, 2,3,5-trihydroxypentane, and mixtures or combinations thereof. Exemplary trihydroxyhexanes include 1,2,3-trihydroxyhexane, 1,2,4-trihydroxyhexane, 1,2,5-trihydroxyhexane, 1,2,6-trihydroxyhexane, 2,3,4-rihydroxyhexane, 2,3,5-trihydroxyhexane, 2,3,6-rihydroxyhexane, and mixtures or combinations thereof. Exemplary trihydroxybenznes include 1,2,3-trihydroxybenzene, 1,2,4-trihydroxybenzene, 1,3,5-trihydroxybenzene, and mixtures or combinations thereof. Exemplary trihydroxytoluenes include 2,3,5-trihydroxytoluene, 2,3,6-trihydroxytoluene, 2,4,5-trihydroxytoluene, 2,4,6-trihydroxytoluene, 3,4,5-trihydroxytoluene, and mixtures or combinations thereof.

### Secondary Winterizing Agents

Suitable secondary winterizing agents for use in the present invention include, without limitation, glycols, alcohols, glymes, glycerols, non-ionic surfactants, dioxolane, and mixtures or combinations thereof. Exemplary examples of the secondary winterizing agents include, without limitation, ethylene glycol, triethylene glycol, ethylene glycol monobutylether, polypropylene glycol 425MW (H[OCH(CH₃)CH₂]ₙOH, where n=5.6), glycol ether DPM (CH₃O[CH₂CH(CH₃)O]₂H), methanol, propylene glycol (OHCH₂CH(CH₃)OH), RhodiaSolv MSOL (isopropylidene glycerol), ECOSURF®EH14 (2ethyl Hexanol EOVPO Nonionic Surfactant), TERGITOL™ 15-S-12 (CH₁₂₋₂₄₋₂₅₋₂₉O[CH₂CH₂O)ₓ]H), TERGITOL™ NP-15 (Nonylphenol Ethoxylate surfactant), (1-(OCH₂CH₂)ₓOH,4-C₉H₁₉-benzene, where x=15), poly(ethylene glycol) dimethyl ether (polyglyme) (CH₃—O—(CH₂CH₂—O)ₙ—CH₃), where n is greater than 4, dioxolane (1,3-dioxolane), diethylene glycol monobutyl ether (butyl carbitol) (C₄H₉ (OCH₂CH₂)₂OH), diethylene glycol (HOVCH₂CH₂OCH₂CH₂OH), and mixtures or combinations thereof.

### Noxious Sulfur Species

The noxious sulfur species that are scavenged by the triazine sulfur scavengers of this invention including, without limitation, hydrogen sulfide (H₂S), thiols (RSH, where R is a hydrocarbyl group), low molecular weight dialklysulfides (R₂S, where each are R is independently, a hydrocarbyl group), other sulfur active sulfur agents, or mixtures or combinations thereof. The triazine sulfur scavengers react with these noxious sulfur species to form sulfur containing compounds that are relatively inert in the gas or fluids being produced from oil and/or gas wells.

### Other Additives

Gas Hydrate Inhibitors

Suitable gas hydrate treating chemicals or inhibitors that are useful for the practice of the present invention include, but are not limited to, polymers and homopolymers and copolymers of vinyl pyrrolidone, vinyl caprolactam and amine based hydrate inhibitors such as those disclosed in Patent Publication Nos. 2006/0223713 and 2009/0325823, both of which are herein incorporated by reference. Other gas hydrates include, without limitation, polyvinylcaprolactam (PVCap), (b) a polyesteramide made from di-2-propanolamine and hexahydrophthalic anhydride, (c) alkyl ether tributylammonium bromide AAs (R has 12-14 carbon atoms), (d) tri-butylammoniumpropylsulfonate (TBAPS). Other gas hydrate inhibitors include, without, quaternary ammonium salts; polymeric n-vinyl-2-pyrrolidone; methanol-based solution of the polymer n-vinyl, n-methyl acetamide-covinyl caprolactam; and borate-crosslinked gel systems. All of these gas hydrate inhibitors may be used individually or collectively.

Corrosion Inhibitors

Suitable corrosion inhibitor for use in this invention include, without limitation: quaternary ammonium salts e.g., chloride, bromides, iodides, dimethylsulfates, diethylsulfates, nitrites, bicarbonates, carbonates, hydroxides, alkoxides, or the like, or mixtures or combinations thereof; salts of nitrogen bases; or mixtures or combinations thereof. Exemplary quaternary ammonium salts include, without limitation, quaternary ammonium salts from an amine and a quaternarization agent, e.g., alkylchlorides, alkylbromide, alkyl iodides, alkyl sulfates such as dimethyl sulfate, diethyl sulfate, etc., dihalogenated alkanes such as dichloroethane, dichloropropane, dichloroethyl ether, epichlorohydrin adducts of alcohols, ethoxylates, or the like; or mixtures or combinations thereof and an amine agent, e.g., alkylpyridines, especially, highly alkylated alkylpyridines, alkyl quinolines, C6 to C24 synthetic tertiary amines, amines derived from natural products such as coconuts, or the like, dialkylsubstituted methyl amines, amines derived from the reaction of fatty acids or oils and polyamines, amidoimidazolines of DETA and fatty acids, imidazolines of ethylenediamine, imidazolines of diaminocyclohexane, imidazolines of aminoethylethylenediamine, pyrimidine of propane diamine and alkylated propene diamine, oxyalkylated mono and polyamines sufficient to convert all labile hydrogen atoms in the amines to oxygen containing groups, or the like or mixtures or combinations thereof. Exemplary examples of salts of nitrogen bases, include, without limitation, salts of nitrogen bases derived from a salt, e.g.: C1 to C8 monocarboxylic acids such as formic acid, acetic acid, propanoic acid, butanoic acid, pentanoic acid, hexanoic acid, heptanoic acid, octanoic acid, 2-ethylhexanoic acid, or the like; C2 to C12 dicarboxylic acids, C2 to C12 unsaturated carboxylic acids and anhydrides, or the like; polyacids such as diglycolic acid, aspartic acid, citric acid, or the like; hydroxy acids such as lactic acid, itaconic acid, or the like; aryl and hydroxy aryl acids; naturally or synthetic amino acids; thioacids such as thioglycolic acid (TGA); free acid forms of phosphoric acid derivatives of glycol, ethoxylates, ethoxylated amine, or the like, and aminosulfonic acids; or mixtures or combinations thereof and an amine, e.g.: high molecular weight fatty acid amines such as cocoamine, tallow amines, or the like; oxyalkylated fatty acid amines; high molecular weight fatty acid polyamines (di, tri, tetra, or higher); oxyalkylated fatty acid polyamines; amino amides such as reaction products of carboxylic acid with polyamines where the equivalents of carboxylic acid is less than the equivalents of reactive amines and oxyalkylated derivatives thereof; fatty acid pyrimidines; monoimidazolines of EDA, DETA or higher ethylene amines, hexamethylene diamine (HMDA), tetramethylenediamine (TMDA), and higher analogs thereof; bisimidazolines, imidazolines of mono and polyorganic acids; oxazolines derived from monoethanol amine and fatty acids or oils, fatty acid ether amines, mono and bis amides of aminoethylpiperazine; GAA and TGA salts of the reaction products of crude tall oil or distilled tall oil with diethylene triamine; GAA and TGA salts of reaction products of dimer acids with mixtures of poly amines such as TMDA, HMDA and 1,2-diaminocyclohexane; TGA salt of imidazoline derived from DETA with tall oil fatty acids or soy bean oil, canola oil, or the like; or mixtures or combinations thereof.

pH Modifiers

Suitable pH modifiers for use in this invention include, without limitation, alkali hydroxides, alkali carbonates, alkali bicarbonates, alkaline earth metal hydroxides, alkaline earth metal carbonates, alkaline earth metal bicarbonates, rare earth metal carbonates, rare earth metal bicarbonates, rare earth metal hydroxides, amines, hydroxylamines (NH₂OH), alkylated hydroxyl amines (NH₂OR, where R is a carbyl group having from 1 to about 30 carbon atoms or heteroatoms—O or N), and mixtures or combinations thereof. Preferred pH modifiers include NaOH, KOH, Ca(OH)₂, CaO, Na₂CO₃, KHCO₃, K₂CO₃, NaHCO₃, MgO, Mg(OH)₂ and mixtures or combinations thereof. Preferred amines include triethylamine, triproplyamine, other trialkylamines, bis hydroxyl ethyl ethylenediamine (DGA), bis hydroxyethyl diamine 1-2 dimethylcyclohexane, or the like or mixtures or combinations thereof.

Scale Control

Suitable additives for Scale Control and useful in the compositions of this invention include, without limitation: Chelating agents, e.g., Na⁺, K⁺ or NH salts of EDTA; Na, K or NH salts of NTA; Na⁺, K⁺ or NH salts of Erythorbic acid; Na⁺, K⁺ or NH salts of thioglycolic acid (TGA); Na⁺, K⁺ or NH salts of Hydroxy acetic acid; Na⁺, K⁺ or NH salts of Citric acid; Na⁺, K⁺ or NH salts of Tartaric acid or other similar salts or mixtures or combinations thereof. Suitable additives that work on threshold effects, sequestrants, include, without limitation: Phosphates, e.g., sodium hexamethylphosphate, linear phosphate salts, salts of polyphosphoric acid, Phosphonates, e.g., nonionic such as HEDP (hydroxythylidene diphosphoric acid), PBTC (phosphoisobutane, tricarboxylic acid), Amino phosphonates of: MEA (monoethanolamine), NH₃, EDA (ethylene diamine), Bishydroxyethylene diamine, Bisaminoethylether, DETA (diethylenetriamine), HMDA (hexamethylene diamine), Hyper homologues and isomers of HMDA, Polyamines of EDA and DETA, Diglycolamine and homologues, or similar polyamines or mixtures or combinations thereof; Phosphate esters, e.g., polyphosphoric acid esters or phosphorus pentoxide (P₂O₅) esters of: alkanol amines such as MEA, DEA, triethanol amine (TEA), Bishydroxyethylethylene diamine; ethoxylated alcohols, glycerin, glycols such as EG (ethylene glycol), propylene glycol, butylene glycol, hexylene glycol, trimethylol propane, pentaerythritol, neopentyl glycol or the like; Tris & Tetra hydroxy amines; ethoxylated alkyl phenols (limited use due to toxicity problems), Ethoxylated amines such as monoamines such as MDEA and higher amines from 2 to 24 carbons atoms, diamines 2 to 24 carbons carbon atoms, or the like; Polymers, e.g., homopolymers of aspartic acid, soluble homopolymers of acrylic acid, copolymers of acrylic acid and methacrylic acid, terpolymers of acylates, AMPS, etc., hydrolyzed polyacrylamides, poly malic anhydride (PMA); or the like; or mixtures or combinations thereof.

Carbon Dioxide Neutralization

Suitable additives for CO₂ neutralization and for use in the compositions of this invention include, without limitation, MEA, DEA, isopropylamine, cyclohexylamine, morpholine, diamines, dimethylaminopropylamine (DMAPA), ethylene diamine, methoxy proplyamine (MOPA), dimethylethanol amine, methyldiethanolamine (MDEA) & oligomers, imidazolines of EDA and homologues and higher adducts, imidazolines of aminoethylethanolamine (AEEA), aminoethylpiperazine, aminoethylethanol amine, di-isopropanol amine, DOW AMP-90™, Angus AMP-95, dialkylamines (of methyl, ethyl, isopropyl), mono alkylamines (methyl, ethyl, isopropyl), trialkyl amines (methyl, ethyl, isopropyl), bishydroxyethylethylene diamine (THEED), or the like or mixtures or combinations thereof.

Paraffin Control

Suitable additives for Paraffin Removal, Dispersion, and/or paraffin Crystal Distribution include, without limitation: Cellosolves available from DOW Chemicals Company; Cellosolve acetates; Ketones; Acetate and Formate salts and esters; surfactants composed of ethoxylated or propoxylated alcohols, alkyl phenols, and/or amines; methylesters such as coconate, laurate, soyate or other naturally occurring methylesters of fatty acids; sulfonated methylesters such as sulfonated coconate, sulfonated laurate, sulfonated soyate or other sulfonated naturally occurring methylesters of fatty acids; low molecular weight quaternary ammonium chlorides of coconut oils soy oils or C₁₀ to C₂₄ amines or monohalogenated alkyl and aryl chlorides; quanternary ammonium salts composed of disubstituted (e.g., dicoco, etc.) and lower molecular weight halogenated alkyl and/or aryl chlorides; gemini quaternary salts of dialkyl (methyl, ethyl, propyl, mixed, etc.) tertiary amines and dihalogenated ethanes, propanes, etc. or dihalogenated ethers such as dichloroethyl ether (DCEE), or the like; gemini quaternary salts of alkyl amines or amidopropyl amines, such as cocoamidopropyldimethyl, bis quaternary ammonium salts of DCEE; or mixtures or combinations thereof. Suitable alcohols used in preparation of the surfactants include, without limitation, linear or branched alcohols, specially mixtures of alcohols reacted with ethylene oxide, propylene oxide or higher alkyleneoxide, where the resulting surfactants have a range of HLBs. Suitable alkylphenols used in preparation of the surfactants include, without limitation, nonylphenol, decylphenol, dodecylphenol or other alkylphenols where the alkyl group has between about 4 and about 30 carbon atoms. Suitable amines used in preparation of the surfactants include, without limitation, ethylene diamine (EDA), diethylenetriamine (DETA), or other polyamines. Exemplary examples include Quadrols, Tetrols, Pentrols available from BASF. Suitable alkanolamines include, without limitation, monoethanolamine (MEA), diethanolamine (DEA), reactions products of MEA and/or DEA with coconut oils and acids.

Oxygen Control

The introduction of water downhole often is accompanied by an increase in the oxygen content of downhole fluids due to oxygen dissolved in the introduced water. Thus, the materials introduced downhole must work in oxygen environments or must work sufficiently well until the oxygen content has been depleted by natural reactions. For system that cannot tolerate oxygen, then oxygen must be removed or controlled in any material introduced downhole. The problem is exacerbated during the winter when the injected materials include winterizers such as water, alcohols, glycols, Cellosolves, formates, acetates, or the like and because oxygen solubility is higher to a range of about 14-15 ppm in very cold water. Oxygen can also increase corrosion and scaling. In CCT (capillary coiled tubing) applications using dilute solutions, the injected solutions result in injecting an oxidizing environment (O₂) into a reducing environment (CO₂, H₂S, organic acids, etc.).

Options for controlling oxygen content includes: (1) de-aeration of the fluid prior to downhole injection, (2) addition of normal sulfides to product sulfur oxides, but such sulfur oxides can accelerate acid attack on metal surfaces, (3) addition of erythorbates, ascorbates, diethylhydroxyamine or other oxygen reactive compounds that are added to the fluid prior to downhole injection; and (4) addition of corrosion inhibitors or metal passivation agents such as potassium (alkali) salts of esters of glycols, polyhydric alcohol ethyloxylates or other similar corrosion inhibitors. Exemplary examples oxygen and corrosion inhibiting agents include mixtures of tetramethylene diamines, hexamethylene diamines, 1,2-diaminecyclohexane, amine heads, or reaction products of such amines with partial molar equivalents of aldehydes. Other oxygen control agents include salicylic and benzoic amides of polyamines, used especially in alkaline conditions, short chain acetylene diols or similar compounds, phosphate esters, borate glycerols, urea and thiourea salts of bisoxalidines or other compound that either absorb oxygen, react with oxygen or otherwise reduce or eliminate oxygen.

Salt Inhibitors

Suitable salt inhibitors for use in the fluids of this invention include, without limitation, Na Minus-Nitrilotriacetamide available from Clearwater International, LLC of Houston, Tex.

### Compositional Ranges for Use in the Invention

In certain embodiment, the winterizing compositions of this invention comprise 100 wt. % of a crude glycerine, an aqueous solution including between about 50 wt. % to about 90 wt. % glycerine in water. In other embodiments, the crude glycerine solution includes between about 70 wt. % to about 90 wt. % glycerine in water. In other embodiments, the crude glycerine solution includes between about 70 wt. % to about 85 wt. % glycerine in water. In other embodiments, the crude glycerine solution includes between about 75 wt. % to about 85 wt. % glycerine in water.

In certain embodiments, the winterizing compositions of this invention include a crude glycerine solution and a secondary winterizing agents. Table 1 lists embodiments of blends of a crude glycerine solution including the indicated amounts of crude glycerin and of the indicated secondary winterizing agent.

TABLE 1
Blends of Crude Glycerine and Secondary Winterizing Agents

| Blend | Embodiment 1 | Embodiment 2 | Embodiment 3 |
|---|---|---|---|
| CGly/EG | 99 wt. % to 15 wt. % CGly | 99 wt. % to 10 wt. % CGly | 1 wt. % to 99 wt. % Cly |
| | 1 wt. % to 85 wt. % EG | 1 wt. % to 90 wt. % EG | 1 wt. % to 90 wt. % EG |
| CGly/TEG | 99 wt. % to 65 wt. % CGly | 99 wt. % to 40 wt. % CGly | 99 wt. % to 15 wt. % CGly |
| | 1 wt. % to 35 wt. % TEG | 1 wt. % to 60 wt. % TEG | 1 wt. % to 85 wt. % TEG |
| CGly/EB | 99 wt. % to 50 wt. % CGly | 99 wt. % to 15 wt. % CGly | 99 wt. % to 1 wt. % CGly |
| | 1 wt. % to 50 wt. % EB | 1 wt. % to 85 wt. % EB | 1 wt % to 99 wt. % EB |
| CGly/PPG | 99 wt. % to 85 wt. % CGly | 99 wt. % to 70 wt. % CGly | 99 wt. % to 60 wt. % CGly |
| | 1 wt. % to 15 wt. % PPG | 1 wt. % to 30 wt. % PPG | 1 wt. % to 40 wt. % PPG |
| CGly/DPM | 99 wt. % to 70 wt. % CGly | 99 wt. % to 50 wt. % CGly | 99 wt. % to 30 wt. % CGly |
| | 1 wt. % to 30 wt. % DPM | 1 wt. % to 50 wt. % DPM | 1 wt. % to 70 wt. % DPM |
| CGly/PG | 99 wt. % to 45 wt. % CGly | 99 wt. % to 1 wt. % CGly | 99 wt. % to 1 wt. % CGly |
| | 1 wt. % to 55 W% PG | 1 wt. % to 99 W% PG | 1 wt % to 99 wt. % PG |
| CGly/MSOL | 99 wt. % to 80 wt. % CGly | 99 wt. % to 65 wt. % CGly | 99 wt. % to 50 wt. % CGly |
| | 1 wt. % to 20 wt. % MSOL | 1 wt. % to 35 wt. % MSOL | 1 wt. % to 50 wt. % MSOL |
| CGly/Gly | 99 wt. % to 1 wt. % CGly | 99 wt. % to 1 wt. % CGly | 99 wt. % to 1 wt. % CGly |
| | 1 wt. % to 99 wt. % Gly | 1 wt. % to 99 wt. % Gly | 1 wt. % to 99 wt. % Gly |
| CGly/Eco | 99 wt. % to 70 wt. % CGly | 99 wt. % to 50 wt. % CGly | 99 wt. % to 30 wt. % CGly |
| | 1 wt. % to 30 wt. % Eco | 1 wt. % to 50 wt. % Eco | 1 wt. % to 70 wt. % Eco |
| CGly/Terg | 99 wt. % to 75 wt. % CGly | 99 wt. % to 60 wt. % CGly | 99 wt. % to 40 wt. % CGly |
| | 1 wt. % to 25 wt. % Terg | 1 wt. % to 40 wt. % Terg | 1 wt. % to 60 wt. % Terg |
| CGly/NP-15 | 99 wt. % to 70 wt. % CGly | 99 wt. % to 50 wt. % CGly | 99 wt. % to 25 wt. % CGly |
| | 1 wt. % to 30 wt % NP-15 | 1 wt. % to 50 wt. % NP-15 | 1 wt. % to 75 wt % NP-15 |
| CGly/PGm | 99 wt. % to 95 wt. % CGly | 99 wt. % to 90 wt. % CGly | 99 wt. % to 80 wt. % CGly |
| | 1 wt. % to 5 wt % PGm | 1 wt. % to 10 wt. % PGm | 1 wt. % to 20 wt. % PGm |
| CGly/Dio | 99 wt. % to 90 wt. % CGly | 99 wt. % to 80 wt. % CGly | 99 wt. % to 60 wt. % CGly |
| | 1 wt. % to 10 wt. % Dio | 1 wt. % to 20 wt. % Dio | 1 wt. % to 40 wt. % Dio |
| CGly/BC | 99 wt. % to 55 wt. % CGly | 99 wt. % to 25 wt. % CGly | 99 wt. % to 1 wt. % CGly |
| | 1 wt. % to 45 wt. % BC | 1 wt. % to 75 wt. % BC | 1 wt. % to 99 wt. % BC |
| CGly/DEG | 99 wt. % to 55 wt. % CGly | 99 wt. % to 10 wt. % CGly | 99 wt. % to 1 wt. % CGly |
| | 1 wt. % to 45 wt. % DEG | 1 wt. % to 90 wt. % DEG | 1 wt. % to 99 wt. % DEG |

In certain embodiments, the winterized compositions of this invention is used according to the formula:

EA=X*GP*C_{H2S}

wherein EA is the effective amount in liters per day (lpd), X is a multiplier of from about 0.1 to about 0.5, or 0.2 to about 0.4, or 0.25 to 0.35, or 0.3, GP is the amount of hydrocarbon stream treated in million standard cubic feet per day (MMscfd), and C_{H2S} is the concentration of H₂S in parts per million (ppm).

### Experiments of the Invention

A problem exists with current industry freeze-protected scavenger solutions when the solutions are exposed to temperatures between 40° C. and 60° C. In this temperature range, many of the solvents used to lower the pour point have high evaporate rates causing the scavenger solutions to become highly viscous and difficult to transfer. The following experiments were performed with triazine sulfur scavengers to evidence the utility of the winterizing compositions of this invention. The inventors have found that the winterizing agents of this invention are capable of freeze protecting solutions containing 42% active triazine scavengers to temperatures of less than or equal to −40° C. with an acceptably low evaporation rate. Lowering the evaporation rates increases the stability of scavenger solutions, which allows the solutions to maintain a workable viscosity for a longer or workable period of time.

### Base Fluids

The following examples used several starting base solutions. One base solution included Sulfa Clear® 8440 TM pre water and methanol addition is the least expensive of the base solution and has the highest concentration of water at 40 wt. %. Another base solution is a highly concentrated, vendor provided scavenger including 70 wt. % active scavenger and 30 wt. % water. Another base solution is a Sulfa Clear® 8411 HC solution including 79 wt % active scavenger and 21 wt. % water. Other base solution that were used in the studies set forth below will be identified when used. All lab solutions used Sulfa Clear® 8411 HC instead of Sulfa Clear® 8440 TM diluted down to meet the Sulfa Clear® 8440 TM actives.

Performance testing of solutions V1, V2.2, V4, V5.1, V6.1 and V7.3 showed insignificant decreases in evaporation rate and/or increases in scavenging performance. Performance testing of solutions V1, V1.1, V13, and V13.7 showed the decreases in evaporation rate and/or increases in scavenging performance.

After determining that winterizing compositions including at least one triol showed good evaporation rate and/or scavenging performance after exposure to temperatures between 40° C. and 60° C., toll manufactured Sulfa Clear® 8440 TM was pulled before methanol and water were added. These scavenger solutions were labeled with an “M”.

### Pour Point Procedure

The pour point values were determined according to the following procedure:
1. Each sample was placed in a freezer with a thermometer inserted into solution.
2. The temperature of the freezer was adjusted to an estimated pour point temperature.
3. Each sample was checked once it reached the temperature of the freezer.
4. Each sample was held in a horizontal position for a three second count. The temperature at which each sample no longer flows after the three second count was considered the pour point temperature.
5. If a sample flows before the three second count, the freezer temperature was lowered and steps 3 and 4 were repeated.
6. If a sample doesn't flow after the three second count, the freeze temperatures was increased and steps 3 and 4 were repeated to determine what temperature it would start pouring at again.

### Evaporation Rate Procedure

This test is not a standard evaporation rate test. It was simply designed to provide a general comparison of the different samples. The evaporation rates were determined according to the following procedure:
1. Each sample was poured into a separate 100 mL graduated cylinder up to 100 mL mark and the record the amount of mass added.
2. Each graduated cylinder was placed into a water bath heated to 60° C. (140° F.) so that as much of each graduated cylinder was submerge to ensure even heating.
3. Each sample was allowed to sit in the water batch for 24 hours.
4. Volume and mass of each graduate cylinder were recorded after the 24 hour waiting period to determine changes is volume and mass for each sample.
5. The lost mass was divided by 24 hours to get an evaporation rate for each sample.

TABLE 1
Solutes and Their Properties

| | | | | VPt^{b} | | |
|---|---|---|---|---|---|---|
| Solute | | | FPt^{a} | (hPa at | FlPt^{c} | Bpt^{d} |
| # | Solute | Abbr. | (° C.) | 20° C.) | (° C.) | (° C.) |
| 1 | Ethylene glycol | EG | −13 | 0.066 | 111 | 197.5 |
| 2 | Ethylene glycol | EB | −70 | 0.80 | 72 | 171 |
| | monobutylether | | | | | |
| 3 | Methanol | MeOH | −97.6 | 13.02 | 11 | 64.7 |
| 4 | Propylene glycol | PG | −59 | 0.1 | 99 | 188 |
| 5 | Glycol ether DPM | DPM | −83 | 0.5 | 85 | 190 |
| | | | | (at 25° C.) | | |
| 6 | Triethylene glycol | TEG | −4.3 | <0.01 | 177 | 288 |
| 7 | RhodiaSolv MSOL | MSOL | −26 | N/A | 91 | 190 |
| 8 | Polypropylene | PPG | −45 | 0.00133 | 166 | N/A |
| | glycol 425 MW | | | | | |
| 9 | Tergitol 15-S-12 | Terg | 20 | <0.0133 | 227 | ≥502 |
| 10 | Ecosurf EH-14 | Eco | 6 | N/A | 91 | N/A |
| 11 | N.P. 15 mol | NP-15 | 23 | N/A | 169 | N/A |
| 12 | Glycerine | Gly | 17.8 | N/A | 199 | N/A |
| 13 | Crude glycerine | CGly | <2 | N/A | >120 | >130 |
| 14 | Dioxolane | Dio | −95 | 114 | −6 | 75.6 |
| 15 | Polyglyme | PGm | −28 | <0.01 | >130 | 275 |
| 16 | Diethylene glycol | BC | −68 | 0.04 | 124 | 230 |
| | monobutylether | | | | | |
| 17 | Diethylene glycol | DEG | −10 | 0.04 | 123 | 245 |

^{a}Freezing Point;
^{b}Vapor Pressure;
^{c}Flash Point;
^{d}BoilingPoint

Samples were formulated by charging 8411HC into a vessel with mixing. Then the indicated amount of water and solute were added to the vessel and the sample was mixed until the sample was homogeneous. Tables 2A-C list the formulations for each of the samples.

TABLE 2A
Formulations Using 8440TM
as Base Solution (BS1)

| | BS1 | Water | | Solute |
|---|---|---|---|---|
| Sample | (wt. %) | (wt. %) | Solute | (wt. %) |
| BS1^{a} | 54.2 | 45.8 | — | — |
| V1 | 54.2 | 21.8 | EG | 24 |
| V1.1 | 54.2 | 15.8 | EG | 30 |
| V2 | 54.2 | 21.8 | EB | 54.2 |
| V2.2 | 54.2 | 7.8 | EB | 38 |
| V3 | 54.2 | 21.8 | MeOH | 24 |
| V4 | 54.2 | 21.8 | PG | 24 |
| V4.1 | 54.2 | 15.8 | PG | 30 |
| V5.1 | 54.2 | 15.8 | DPM | 30 |
| V6.1 | 54.2 | 15.8 | TEG/EB | 15/15 |
| V7.3 | 54.2 | 10.8 | MSOL | 35 |
| V8 | 54.2 | 15.8 | PPG/PG | 15/15 |
| V9 | 54.2 | 15.8 | EG, Terg | 15/15 |
| V10 | 54.2 | 15.8 | EG/Eco | 15/15 |
| V11 | 54.2 | 15.8 | EG/NP-15 | 15/15 |
| V13 | 54.2 | 15.8 | Gly | 30 |
| V13.7 | 54.2 | 15.8 | CGyl | 30 |
| V15 | 54.2 | 15.8 | PGm | 30 |

^{a}42 wt. % active base solution

TABLE 2B
Solutions Using 70% Active
Vendor Base Solution (BS2)

| | BS2 | Water | | Solute |
|---|---|---|---|---|
| Sample | (wt. %) | (wt. %) | Solute | (wt. %) |
| BS2^{a} | 69.68 | 30.32 | — | — |
| V1.3 | 69.53 | 7.47 | EG | 23 |
| V1.5 | 54.2 | 5.82 | EG | 39.98 |
| V4.3 | 67.73 | 7.27 | PG | 25 |
| V5.3 | 65.02 | 6.98 | DPM | 65.02 |
| V7.5 | 67.73 | 7.27 | MSOL | 25 |
| V13.5 | 69.53 | 7.47 | Gly | 23 |
| V13.6 | 54.2 | 5.84 | Gly | 39.98 |
| V14.1 | 69.53 | 7.57 | TEG/Dio | 11.5/11.5 |

^{a}54 wt. % active base solution

TABLE 2C
Solutions Using SC 8411HC
as Base Solution (BS3)

| | BS3 | Water | | Solute |
|---|---|---|---|---|
| Sample | (wt. %) | (wt. %) | Solute | (wt. %) |
| BS3^{a} | 81.3 | 18.7 | — | — |
| V1.4 | 81.5 | — | EG | 18.5 |
| V14 | 81.5 | — | TEG/Dio | 9.25/9.25 |
| V7.6 | 81.15 | — | MSOL | 18.5 |

^{a}63 wt. % active base solution

TABLE 3
Final Composition and Properties BS1 Based Formulations

| | Final Comp. | | | | | Pour Point |
|---|---|---|---|---|---|---|
| Sample | Activity | Solute | Solute (wt. %) | H₂O (wt. %) | Description | (° C.) |
| H₂O | — | — | — | 100 | — | 0 |
| SC8411HC* | 79.5 | — | — | 20.5 | — | 0 |
| BS1 | 42 | — | — | 58 | — | — |
| V1 | 42 | EG | 24 | 34 | A | < −40 |
| V1.1 | 42 | EG | 30 | 28 | B | < −40 |
| V2 | 42 | EB | 24 | 34 | A | −22 |
| V2.2 | 42 | EB | 38 | 7.8 | B | < −40 |
| V3 | 42 | MeOH | 24 | 34 | A | < −40 |
| V4 | 42 | PG | 24 | 34 | A | < −40 |
| V4.1 | 42 | PG | 30 | 28 | B | < −40 |
| V5.1 | 42 | DPM | 30 | 28 | B | < −40 |
| V6.1 | 42 | TEG/EB | 15/15 | 28 | B | < −40 |
| V7.3 | 42 | MSOL | 35 | 23 | B | < −40 |
| V8 | 42 | PPG/PG | 15/15 | 28 | B | < −40 |
| V9 | 42 | EG/Terg | 15/15 | 28 | B | < −40 |
| V10 | 42 | EG/Eco | 15/15 | 28 | B | < −40 |
| V11 | 42 | EG/NP-15 | 15/15 | 28 | B | < −40 |
| V13 | 42 | Gly | 30 | 28 | B | < −40 |
| V13.7 | 42 | CGly | 24 | 32.5 | B | < −40 |
| V15 | 42 | PGm | 30 | 28 | B | < −40 |

| | | | % Solution | | |
|---|---|---|---|---|---|
| | | Evaporation | Loss After 1 | Viscosity at 50° C. | H₂S |
| Sample | Description | Rate (g/hr.) | day at 60° C. | before Scavenging | Uptake |
| H₂O | — | 0.558 | 13.50 | — | — |
| SC8411HC* | — | 0.137 | 2.86 | — | 1.29 |
| BS1 | — | 0.524 | 11.62 | — | — |
| V1 | A | 0.417 | 8.95 | 7.1 | 2.14 (1.86) |
| V1.1 | B | 0.340 | 7.49 | — | 1.96 |
| V2 | A | 0.471 | — | — | — |
| V2.2 | B | 0.413 | 9.56 | 9.5 | 2.16 |
| V3 | A | 1.165 | 27.18 | — | — |
| V4 | A | 0.397 | 8.69 | 8.8 | 2.10 |
| V4.1 | B | 0.348 | 7.46 | — | — |
| V5.1 | B | 0.385 | 8.64 | 10.8 | 2.12 |
| V6.1 | B | 0.457 | 10.07 | 10.2 | 2.16 |
| V7.3 | B | 0.336 | 7.26 | 13.6 | 2.06 |
| V8 | B | Separated | — | — | — |
| V9 | B | Separated | — | — | — |
| V10 | B | Separated | — | — | — |
| V11 | B | Separated | — | — | — |
| V13 | B | 0.300 | 6.31 | — | 1.61 |
| V13.7 | B | 0.367 | 7.77 | — | 1.45 |
| V15 | B | 0.348 | 7.66 | — | — |

A—Solute added until Freeze Protected.
B—Max amount of Solute until 42% Activity.
*Control

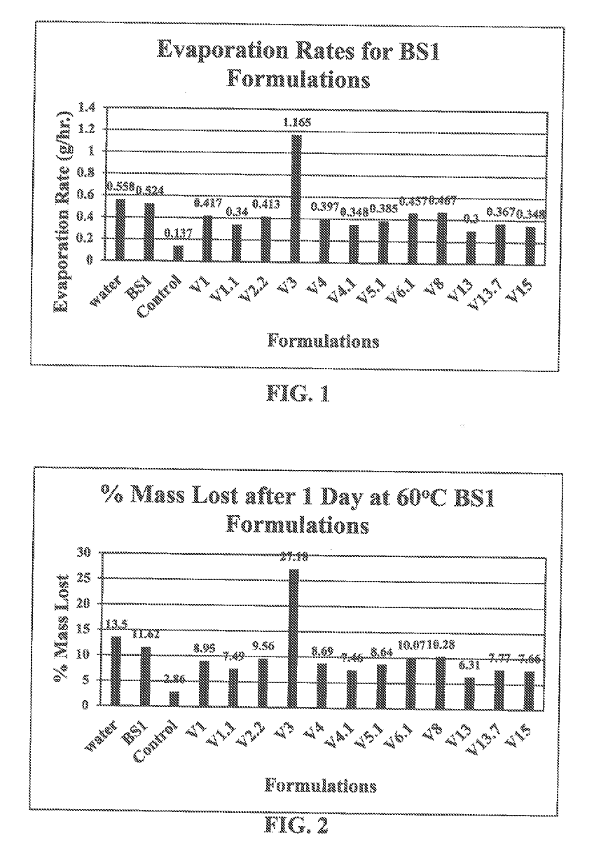

Referring now to FIG. 1, the evaporation rates of the BS1 formulations tabulated in Table 3 are shown, while FIG. 2 shows the % mass loss of the BS1 formulations tabulated in Table 3.

TABLE 4
Final Compositions and Properties BS2 Based Formulations

| | | | Solute | H₂O | | | Pour Point |
|---|---|---|---|---|---|---|---|
| Sample | Activity | Solute | (wt. %) | (wt. %) | Description | S.G. | (° C.) |
| H₂O | — | — | — | 100 | — | — | 0 |
| BS1 | 42 | — | — | 58 | — | 1.14 | < −40 |
| BS2 | 54 | — | — | 46 | — | — | — |
| SC8411HC* | 79.5 | — | — | 20.5 | — | 0 | — |
| V1.1 | 42 | EG | 30 | 28 | B | 1.15 | < −40 |
| V1.3 | 54 | EG | 23 | 23 | A | — | < −40 |
| V1.5 | 42 | EG | 40 | 18 | B | — | < −40 |
| V4.3 | 52.5 | PG | 25 | 22.5 | A | — | < −40 |
| V5.3 | 50 | DPM | 28 | 22 | A | — | < −40 |
| V7.5 | 52.5 | MSOL | 25 | 22.5 | A | — | < −40 |
| V13** | 24 | Gly | 30 | 28 | B | 1.18 | < −40 |
| V13.5 | 54 | Gly | 23 | 23 | A | — | < −40 |
| V13.6 | 42 | Gly | 40 | 18 | B | — | < −40 |
| V13.7 | 42 | CGly | 24 | 32.5 | B | 1.17 | < −40 |
| V14.1 | 53.9 | TEG/Dio | 23 | 23.1 | A | — | < −40 |

| | | % of Solution | Viscosity at | | | |
|---|---|---|---|---|---|---|
| | Evaporation | Lost After 1 | 50° C. before | | pH | H₂S |
| Sample | Rate (g/hr.) | day at 60° C. | Scavenging | Appearance | (neat) | Uptake |
| H₂O | 0.558 | 13.50 | — | — | — | — |
| BS1 | 0.524 | 8.95 | — | clear yellow | 11.05 | — |
| | | | | liquid | | |
| BS2 | 0.488 | 10.59 | — | — | — | — |
| SC8411HC* | 0.137 | 2.86 | — | — | — | |
| V1.1 | 0.340 | 7.49 | — | clear yellow | 10.23 | — |
| | | | | liquid | | |
| V1.3 | 0.247 | 5.26 | — | — | — | — |
| V1.5 | 0.193 | 4.10 | — | — | — | — |
| V4.3 | 0.211 | 4.57 | — | — | — | — |
| V5.3 | 0.281 | 6.24 | — | — | — | — |
| V7.5 | 0.271 | 5.80 | — | — | — | — |
| V13** | 0.300 | 6.31 | — | clear yellow | 10.32 | — |
| | | | | liquid | | |
| V13.5 | 0.177 | 3.68 | — | — | — | — |
| V13.6 | 0.123 | 2.51 | — | — | — | — |
| V13.7 | 0.367 | 7.77 | — | slightly hazy | 9.98 | — |
| | | | | yellow liquid | | |
| V14.1 | 0.249 | 8.66 | — | — | — | — |

A—Solute added until Freeze Protected.
B—Max amount of Solute until 42% Activity.
*Control.
**BS1 based

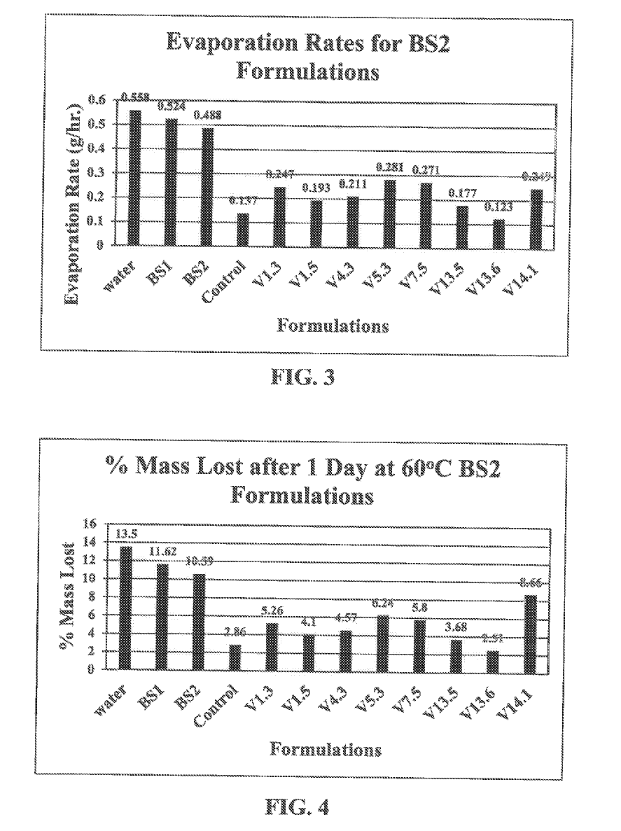

Referring now to FIG. 3, the evaporation rates of the BS1 formulations tabulated in Table 4 are shown, while FIG. 4 shows the % mass loss of the BS1 formulations tabulated in Table 4.

TABLE 5
Final Composition and Properties BS3 Based Formulations

| | | | | | | Pour |
|---|---|---|---|---|---|---|
| | | | Solute | H₂O | | Point |
| Sample | Activity | Solute | (wt. %) | (wt. %) | Description | (° C.) |
| H₂O | — | — | — | 100 | — | 0 |
| BS1 | 42 | — | — | 58 | — | — |
| BS3 | 63.2 | — | — | 36.8 | — | — |
| SC8411HC* | 78 | — | — | 22 | — | — |
| V1.4 | 63.2 | EG | 18.5 | 18.3 | A | < −40 |
| V14 | 63.2 | TEG/Dio | 18.5 | 18.3 | A | < −40 |

| | Evaporation | % of Solution | Viscosity at | |
|---|---|---|---|---|
| | Rate | Lost After 1 | 50° C. before | H₂S |
| Sample | (g/hr.) | day at 60° C. | Scavenging | Uptake |
| H₂O | 0.558 | 13.5 | — | — |
| BS1 | 0.524 | 8.95 | — | 1.29 |
| BS3 | 0.365 | 7.85 | — | — |
| SC8411HC* | 0.137 | 2.86 | — | — |
| V1.4 | 0.144 | 3.03 | — | — |
| V14 | 0.249 | 5.25 | — | — |

A—Solute added until Freeze Protected.
B—Max amount of Solute until 42% Activity.

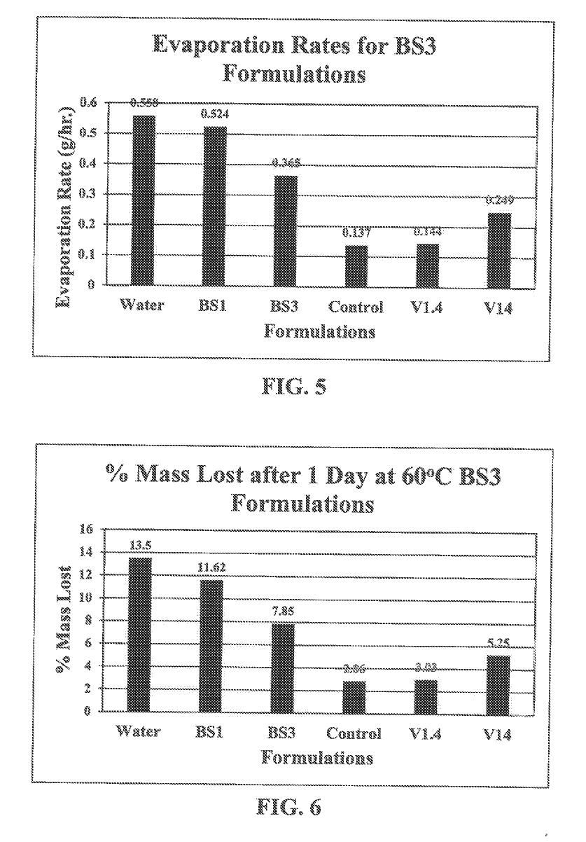

Referring now to FIG. 5, the evaporation rates of the BS1 formulations tabulated in Tables 4 and 5 are shown, while FIG. 6 shows the % mass loss of the BS1 formulations tabulated in Tables 4 and 5.

TABLE 6
Formulations Using 8440TM as Base Fluid

| | 8440TM | | | |
|---|---|---|---|---|
| | PreMeOH | | | |
| | and Water | Water | | Solute |
| Version | (wt. %) | (wt. %) | Solute | (wt. %) |
| BS1 M | 70 | 30 | — | — |
| BS4* M | 100 | — | — | — |
| SC 8440TM | 70 | 15 | MeOH | 15 |
| V1M | 70 | 6 | MeOH | 24 |
| V1.1M | 70 | — | EG | 30 |
| V3M | 70 | 6 | MeOH | 24 |
| V7.1M | 70 | — | MSOL | 30 |
| V13M | 70 | — | Gly | 30 |
| V13.7M | 70 | — | CGly | 30 |
| V13.8M | 70 | — | MSOL/CGly | 6/24 |
| V16M | 70 | — | BC | 30 |
| V17M | 70 | — | DEG | 30 |

*BS4 is a 60% active base solution

TABLE 7
Final Compositions and Properties Using SC8440 TM as Base Fluid

| | | | | | | Pour |
|---|---|---|---|---|---|---|
| | Final Comp. | | | | | Point |
| Sample | Activity | Solute | Solute (wt. %) | H₂O (wt. %) | Description | (° C.) |
| BS1 M | 42 | — | — | 58 | — | 0 |
| 1 M EG-BL | 42 | EG | 24 | 34 | A | < −40 |
| V1.1 M | 42 | EG | 30 | 28 | B | < −40 |
| V3 M | 42 | MeOH | 24 | 34 | A | < −40 |
| V7.1 M | 42 | MSOL | 30 | 28 | B | < −40 |
| V13 M | 42 | Gly | 30 | 28 | B | < −40 |
| V13.7 M | 42 | CGly | ≥24 | 28-32.5** | B | < −40 |
| V13.8 M | 42 | MSOL/CGly | 30 | 28 | B | < −40 |
| | | | % Solution | Initial | Viscosity after | H₂S |
| | | Evaporation | Loss After 1 | Viscosity | 24 Hr. Evap. | Uptake |
| Sample | Description | Rate (g/hr.) | day at 60° C. | (cP) | Test (cP) | (g) |
| BS1 | — | 0.607 | 13.71 | 8.82 | 10.14 | — |
| 1 M EG-BL | A | 0.471 | 10.37 | 16.08 | 18.78 | — |
| V1.1 M | B | 0.387 | 7.49 | 18.30 | 20.67 | — |
| V3 M | A | 1.28 | 30.35 | 10.20 | 16.74 | — |
| V7.1 M | B | 0.583 | 12.84 | 19.68 | 33.29 | — |
| V13 M | B | 0.401 | 8.45 | 29.69 | 55.61 | — |
| V13.7 M | B | 0.407 | 8.63 | 24.41 | 39.83 | — |
| V13.8 M | B | 0.422 | 9.43 | 22.20 | 36.11 | — |

A—Solute added until Freeze Protected.
B—Max amount of Solute until 42% Activity.
Composition may also contain < 1.5% sodium chloride.

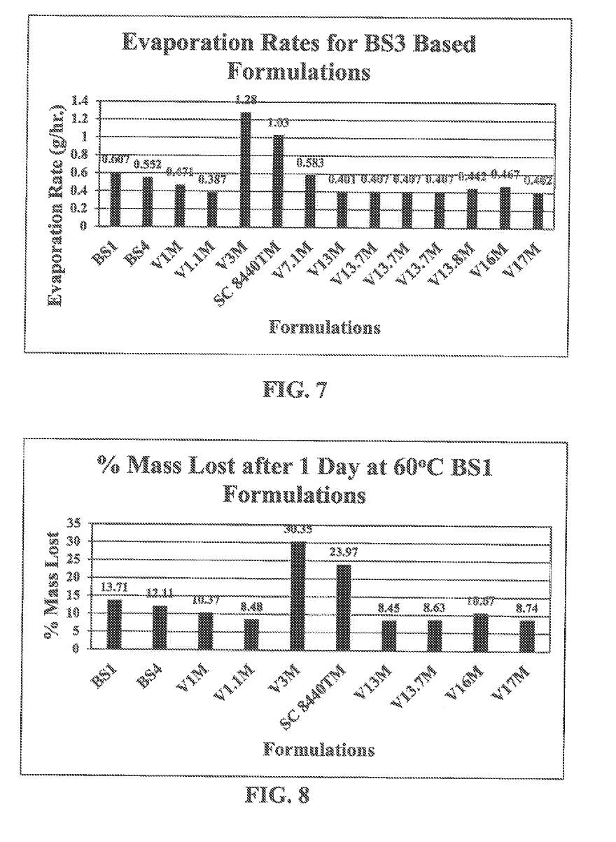

Referring now to FIG. 7, the evaporation rates of the BS1 formulations tabulated in Tables 4 and 7 are shown, while FIG. 8 shows the % mass loss of the BS1 formulations tabulated in Tables 4 and 7.

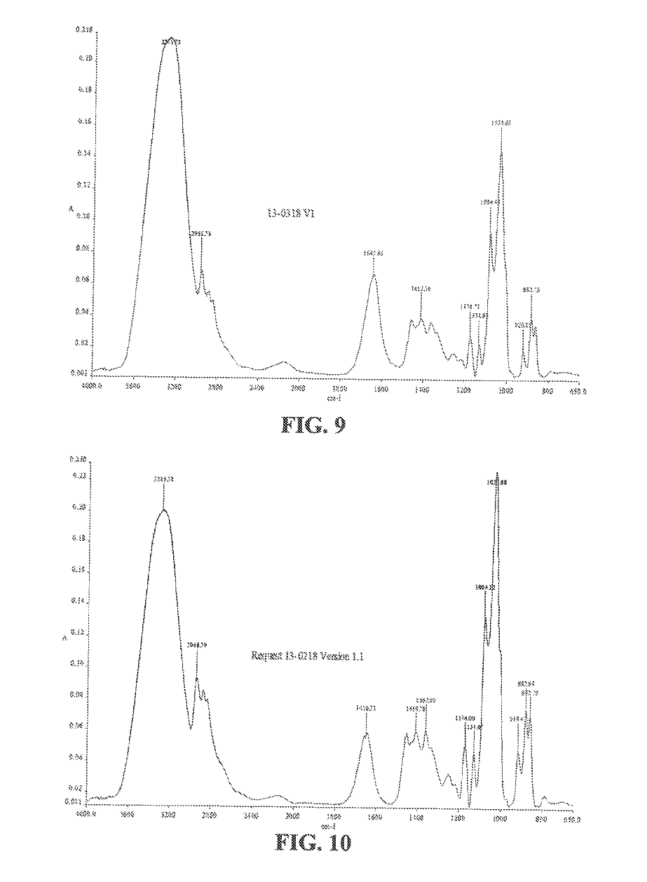

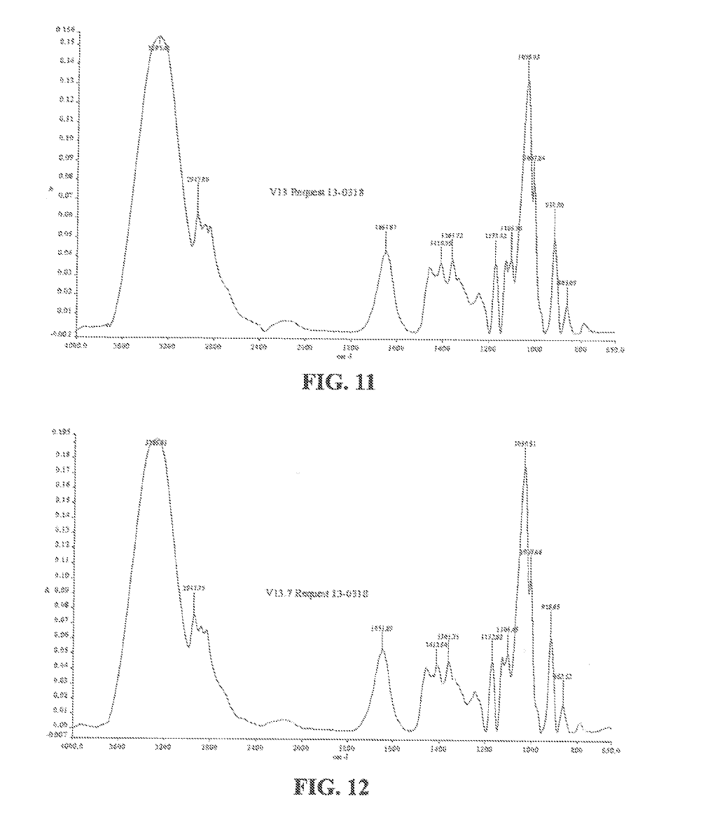

FIG. 9-12 show illustrative IR spectra of V1, V1.1, V13 and V13.7.

### Results and Interpretation

Based on the results of this evaluation, the followings were concluded:
1. The scavenger solution was heated to 50° C. and results for total H₂S gas uptake ranges from 2.06 to 2.16. For all the six results, the mean value was calculated and variance was calculated to find out how close the results are for six products tested. The mean value is 2.12 and the variance is 0.036. The variance close to zero indicates that the results are very close to the mean value and hence to each other.
2. The added materials or components on these triazine-based products did not influence much on the results for H₂S gas uptake at elevated temperature of 50° C.
3. The scavenging capacity of the six products were considerably good as it shows on total time where all has more than 1.5 hours before the gas break out that's been detected by Multiwarn unit.

### Conclusion

V13 had the lowest evaporation rate out of the solutions using Sulfa Clear® 8440TM as their base material as seen in FIG. 1. V13.6 had the lowest evaporation rate for the solutions using the vendor provided 70 wt. % active base as seen in FIG. 3. And lastly, V1.4 had the lowest evaporation rate for the solutions using Sulfa Clear® 8411 HC (SC8411HC) as their base solution, as seen in FIG. 5. Overall the solutions tested, V13.6 had the best evaporation rate at 0.123 g/hr. This evaporation rate is half the amount seen in V1.3 (a current industry product) and 77% less than the 42 wt. % active base solution.

V1 and V2 are current industry products being used by competitors. However, V1 has a lower evaporation rate and is therefore being used as a baseline for this project.

V1.1 showed the greatest decrease in evaporation rate without sacrificing H₂S scavenging performance (see FIG. 1 and FIG. 3), when compared to Vt. In fact, V1.1 resulted in a slightly better performance.

When comparing the different versions to the SC8411HC formulations, it looks like both the ethylene glycol (EG) and glycerin (Gly) winterizing compositions increase the performance of the solutions. However, the EG versions show a higher increase in performance than the Gly versions.

### H₂S Scavenger Uptake Testing

H₂S scavenger testings was performed on pre-formulated products to determine their relative H₂S scavenger performances. The tests were done on cylindrical glass, sparge with 100% gas from bottom to upward action at constant flow rate. Temperature of the scavenger solution was elevated to 50° C. and held at the set temperature constantly. The time of H₂S gas breakout at 2.0 ppm was recorded and used as the basis to compute for total H₂S gas uptake for the formulations.

Other testing was used to evaluate various H₂S scavengers designed for higher temperature applications. The testing compared various blends including a standard scavenger, Sulfa Clear® 8440 TM (SC8440TM) (a MEA triazine sulfur scavenger) available from Clearwater International, LLC and various winterizing compositions to determine how the compositions affected both the viscosity and overall effectiveness of the scavenger.

### Summarized Procedure

The following procedure was used to determine H₂S scavenging properties and break through times, the time it takes for a given H₂S concentration to build in the overhead space:
1. Prepare apparatus set up for the test.
2. Make sure to calibrate H₂S sensor to zero using fresh air and/or air zero gas.
3. Watch for sign of errors and warnings on the Multiwarn unit before proceeding with the run. It may interfere with the results.
4. Make sure Multiwarn sensors for H₂S displays zero on the unit.
5. Pour just above 300 mL of the product in cylindrical glass apparatus.
6. Set up the heating belt around the cylindrical glass with a temperature controller set to 50° C.
7. Confirm the 50° C. temperature of the scavenger solution by using the lollipop thermometer.
8. Bubble the pure H₂S gas at about 90 mm (14.8 mL/min) on an upward flow designed for cylindrical glass. Make some adjustment on the opening if necessary to maintain the desired flow.
9. Start the timer upon first released of ELS gas to cylindrical glass.
10. Record the time upon 2.0 ppm breakout of H₂S gas detected by Multiwarn.
11. Stop the sparging of H₂S gas. Close all valves.
12. Upon completion of each test, ensure all glassware is clean and wastes are disposed properly.
13. Multiwarn should be calibrated back to zero using fresh air and/or air zero gas before the next run.
14. Bleed gas lines and zero out all the pressure gauges.

### Apparatus

The apparatus used to determine the H₂S scavenging properties and break through times included:
1. A pressurized H₂S gas tank supply (CGA30)
2. A gas regulator (Part #403233 Prostar(
3. A correlated flow meter for H₂S gas (Part #130585-101 Muis Control)
4. A 500 mL Pyrex cylindrical glass (Part # SP31760-BO)
5. A heating belt with temperature controller
6. A lollipop thermometer
7. A viscometer (Ofite Model 900 Viscometer)
8. A stop watch
9. Personal Protective Equipment (fume hood, scrubber, lab coat, paper towels, rubber gloves, H₂S gas alert clip, gas mask)

### Results

Table 8 tabulates the results of the H₂S treatment using the above procedure and apparatus for formulations V1, V2.2, V4, V5.1, V6.1, and V7.3.

TABLE 8
Calculated H₂S Gas Uptake to Time Detection
of 2.0 ppm H₂S Concentration at 50° C.

| | | Time to | Calculated | Calculated | |
|---|---|---|---|---|---|
| | | detection | H₂S | H₂S | |
| | Viscosity | of 2.0 | Uptake | Uptake at | |
| | at 50° C. | ppm H₂S | at 2.0 ppm | 2.0 ppm | |
| | 50 RPM | Concentration | detection | detection | |
| Sample | (cP) | (hour:min:sec) | (mL) | (g) | Observations |
| V1 | 7.1 | 01:46:35 | 1569 | 2.14 | Yellowish, clear solution |
| V2.2 | 9.5 | 01:47:27 | 1584 | 2.16 | Yellowish, clear solution |
| V4 | 8.8 | 01:44:29 | 1539 | 2.10 | Yellowish, clear solution |
| V5.1 | 10.8 | 01:45:50 | 1554 | 2.32 | Yellowish, clear solution |
| V6.1 | 10.2 | 01:47:38 | 1584 | 2.16 | Yellowish, clear solution |
| V7.3 | 13.6 | 01:42:08 | 1510 | 2.06 | Yellowish, clear solution |

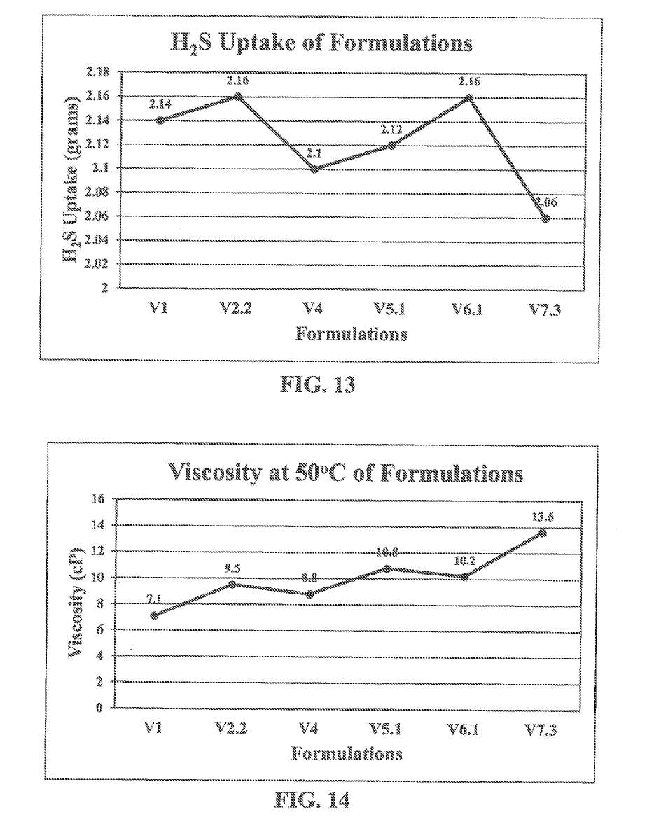

Referring now to FIG. 13, the H₂S uptake data tabulated in Table 8 are shown graphically. Viscosity was run at 50° C. at gas flow rate at 14.8 mL/min and at H₂S gas density of 1.363 are shown in FIG. 14.

### Summarized Procedure

The following procedure was used to determine H₂S scavenging properties and break through times, the time it takes for a given H₂S concentration to build in the overhead space:
1. Prepare apparatus set up for the test.
2. Make sure to calibrate H₂S sensor to zero using fresh air and/or air zero gas.
3. Watch for sign of errors and warnings on the Multiwarn unit before proceeding with the run. It may interfere with the results.
4. Make sure Multiwarn sensors for H₂S displays zero on the unit.
5. Pour just above 300 mL of the scavenger in cylindrical glass apparatus.
6. Sparge the pure H₂S gas at about 90 mm (14.8 mL/min) on an upward flow designed for cylindrical glass. Make some adjustment on the opening if necessary to maintain the desired flow.
7. Start the timer upon first release of H₂S gas to cylindrical glass.
8. Record the time upon 2.0 ppm breakout of H₂S gas detected by Multiwarn.
9. Stop the sparging of H₂S gas. Close all valves.
10. Upon completion of each test, ensure all glassware is clean and wastes are disposed properly.
11. Multiwarn should be calibrated back to zero using fresh air and/or air zero gas before the next run.
12. Bleed gas lines and zero out all the pressure gauges.

### Apparatus

The apparatus used to determine the H₂S scavenging properties and break through times included:
1. Pressurized H₂S gas tank supply (CGA30)
2. Gas Regulator (Part #403233 Prostar)
3. Correlated flow meter for H₂S gas (Part #130585-101 Muis Control)
4. Cylindrical 500 mL Pyrex glass (Part # SP31760-BO)
5. Gas detector from Draeger (Part #8314040)
6. Stop watch
7. Personal Protective Equipment (fume hood, scrubber, lab coat, paper towels, rubber gloves, ELS gas alert clip, gas mask)

### Results

Table 9 tabulates the results of the H₂S treatment using the above procedure and apparatus for formulations V1, V1.1, V13, V13.7, and SC 8411 HC.

TABLE 9
Calculated H₂S Gas Uptake to Time
Detection of 2.0 ppm H₂S

| | Time to | | | |
|---|---|---|---|---|
| | Detection | Calculated | | |
| | of | H₂S | Calculated | |
| | 2.0 ppm | Uptake | H₂S Uptake | |
| | H₂S | at 2.0 ppm | at 2.0 ppm | |
| | Concentration | Detection | Detection | Obser- |
| Samples | (hour:min:sec) | (L) | (g) | vations |
| V1 | 01:32:14 | 1.36 | 1.86 | Clear, |
| | | | | amber |
| | | | | solution |
| V1.1 | 01:38:01 | 1.44 | 1.96 | Clear, |
| | | | | amber |
| | | | | solution |
| V13 | 01:22:15 | 1.18 | 1.61 | Clear, |
| | | | | amber |
| | | | | solution |
| V13.7 | 01:12:21 | 1.07 | 1.45 | Hazy, |
| | | | | amber |
| | | | | solution |
| SC8411HC | 01:04:12 | 0.95 | 1.29 | Clear, |
| | | | | amber |
| | | | | solution |

Gas Flowrate at 14.8 mL/min. H₂S gas density at 1.363 grams/Liter is used to calculate the total gas uptake in grams.

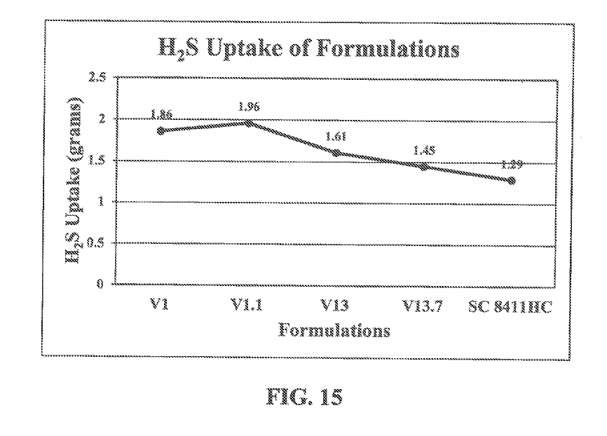

Referring now to FIG. 15, the H₂S uptake data tabulated in Table 9 are shown graphically. All new preformulated products has higher H₂S gas uptake as compare to SC 8411HC. Illustrated on table below is the percentage amount of H₂S uptake that these new products can scavenged more as compared to SC 8411HC.

TABLE 10
% Gain of Variation Formula

| Samples | % Gain |
|---|---|
| SC 8411HC | 0.00% |
| V1 | 44.19% |
| V1.1 | 51.94% |
| V13 | 24.81% |
| V13.7 | 12.40% |

As received, the product V13.7 is amber-hazy as the rest of the products are amber-clear.

TABLE 11
Blend Formulations

| | Content (wt. %) | | | | | |
|---|---|---|---|---|---|---|
| | SC | | | DI | | Activity |
| Blend | 8440 TM | Gly | MeOH | Water | EG | (%) |
| Blend 1 | 70 | 30 | 0 | 0 | 0 | 42 |
| Blend 2 | 70 | 25 | 5 | 0 | 0 | 42 |
| Blend 3 | 70 | 20 | 10 | 0 | 0 | 42 |
| Blend 4 | 70 | 22.5 | 7.5 | 0 | 0 | 42 |
| Blend 5 | 70 | 20 | 5 | 5 | 0 | 42 |
| Blend 6 | 60 | 40 | 0 | 0 | 0 | 36 |
| Blend 7 | 60 | 35 | 5 | 0 | 0 | 36 |
| Blend 8 | 60 | 30 | 10 | 0 | 0 | 36 |
| Blend 9 | 60 | 32.5 | 7.5 | 0 | 0 | 36 |
| Blend 10 | 60 | 30 | 5 | 5 | 0 | 36 |
| Blend 11 | 68 | 27 | 5 | 0 | 0 | 40 |
| Blend 12 | 57 | 43 | 0 | 0 | 0 | 34 |
| Blend 13 | 68 | 24 | 8 | 0 | 0 | 40 |
| Blend 14 | 68 | 27 | 5 | 0 | 0 | 40 |
| Blend 15 | 68 | 20.5 | 8 | 3.5 | 0 | 40 |
| Blend 16 | 68 | 20.5 | 8 | 3.5 | 0 | 40 |
| Blend 17 | 70 | 0 | 10 | 0 | 20 | 42 |
| Blend 18 | 70 | 0 | 30 | 0 | 0 | 42 |

### Testing Procedure

Testing was performed in three stages: (1) determine a freeze-thaw stability of the blends; compare blend viscosities; and (3) compare overall H₂S scavenging effectiveness of the blends.

### Freeze-Thaw and Pour Point Testing

The blend samples were placed in a freezer at approximately −40° C. for two sets of 24 hours and one set of 72 hours. The samples were observed for signs of instability before and after the freeze periods. The blend samples that froze were removed from further testing.

### Viscosity Testing

The technique used to measure the viscosity of the blend sample used a pre-established program involving two specific temperatures and a temperature gradient. The purpose of the viscosity testing is to determine how the various solvent and winterizing additive compositions respond to various temperatures and if they remain constant over time.

### Procedure

The viscosity of the blend samples were determined using the following procedure:
1. The computer program controlling the Julabo F 25 water bath (Rheocalc) was started.
2. The Julabo F 25 chill bath was turned on through the Rheocalc software and the temperature was adjusted to 35° C.
3. The viscometer was turned on and auto zero process was completed.
4. Both cup and spindle were attached to the water jacket holder, which was connected to the chill bath and heated.
5. Approximately 9 mL of each blend was added to the cup.
6. Viscometer was started by adjusting the rpm number to get an initial torque of approximately 10%. Note: This step was performed with the SC 8440 and the resulting speed was applied to all of the blends.
7. Computer program recording the data from the viscometer, Rheocalc, was started.
8. The viscosity measurement was then started by initiating a program in Rheocalc software. The program monitored the viscosity at 35° C. over a period of 2 hours before heating the sample to 50° C. and monitoring the viscosity for a further 2 hours. Upon completion of the 2 hour step at 50° C., the program then monitored the viscosity as the temperature was reduced to approximately −10° C.

### Scavenger Testing

In order to compare the overall effectiveness of the various scavengers, pure H₂S was bubbled through the various blends at a constant rate. The time until gas breakout at 10 ppm was recorded for each blend and used to qualitatively compare the effectiveness of the blends.

### Apparatus

The apparatus for blend testing included:
1. A pressurized H₂S cylinder.
2. A pressure reducer/regulator (H₂S approved).
3. A secondary pressure gauge (smaller scale for more accurate adjustments).
4. A needle valve for fine control of flow.
5. An auxiliary pressure gauge for monitoring blockage of the sparge tube and pressure drop across the needle valve.
6. A sparging apparatus.
7. A timer and second H₂S monitor.
8. A H₂S monitor (vented through additional scavenger).

### Procedure

The scavenging effectiveness of the blends were determined using the following H₂S testing procedure:
1. The testing apparatus was set up for each test.
2. A personal H₂S monitor was zeroed in a fresh air environment and tested with sour gas to confirm functionality.
3. 150 mL of each blend was poured into a 250 mL cylindrical glass apparatus.
4. Pure H₂S gas was passed into the sparging tube using a needle valve to control the flow.
5. The timer was started upon first release of H₂S gas into the sample.
6. The time until H₂S gas breakout was recorded by detecting a 10 ppm on the personal H₂S monitor.
7. Stop the sparging of H₂S gas. Close all valves; bleed off remaining H₂S pressure through a scavenger and purge system with nitrogen to remove trace H₂S.
8. Using fresh air, vent the H₂S monitor and zero it before the next run.

### Results

Freeze-Thaw and Pour Point Testing

Table 12 below lists the finding of this test. If a blend froze (indicating a pour point higher than approx. −40° C.), the blend was considered to fail the pour point test, while blends that remained liquid at −40° C. was considered to pass the pour point test.

TABLE 12
Results of Freeze-Thaw
and Pour Point Testing

| | | Estimated | Pass/ |
|---|---|---|---|
| Blend | Stability | Pour Point | Fail |
| Blend 1 | Stable | >−40° C. | Fail |
| Blend 2 | Stable | >−40° C. | Fail |
| Blend 3 | Stable | <−40° C. | Pass |
| Blend 4 | Stable | <−40° C. | Pass |
| Blend 5 | Stable | >−40° C. | Fail |
| Blend 6 | Stable | >−40° C. | Fail |
| Blend 7 | Stable | <−40° C. | Pass |
| Blend 8 | Stable | <−40° C. | Pass |
| Blend 9 | Stable | <−40° C. | Pass |
| Blend 10 | Stable | >−40° C. | Fail |
| Blend 11 | Stable | <−40° C. | Pass |
| Blend 12 | Stable | >−40° C. | Fail |
| Blend 13 | Stable | <−40° C. | Pass |
| Blend 14 | Stable | <−40° C. | Pass |
| Blend 15 | Stable | <−40° C. | Pass |
| Blend 16 | Stable | <−40° C. | Pass |
| Blend 17 | Stable | <−40° C. | Pass |

Viscosity Testing

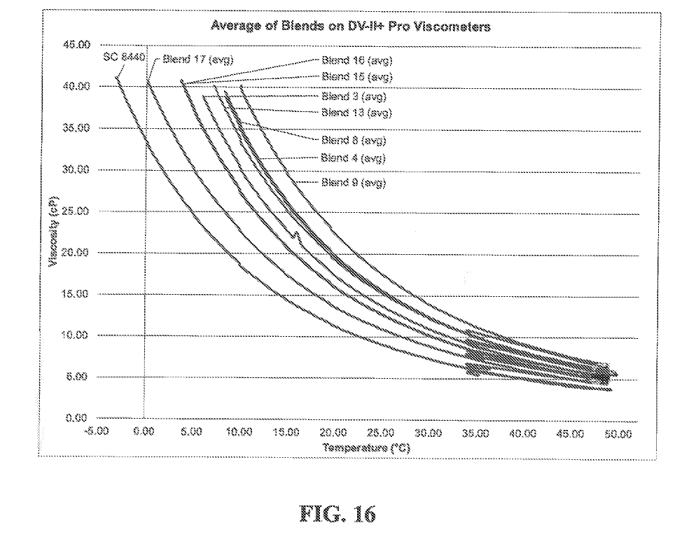

Viscosity testing were conducted at a spindle speed of 80.00 rpm and a shear rate of 105.60 sec⁻¹ for the duration of the test outlined in the above procedure. All of the blends that passed the Freeze-Thaw stage of testing were ran in duplicate. The graph below showed the average viscosity of the duplicate runs for selected products as a function of temperature and how they compare to SC8440TM under the given conditions. FIG. 16 shows scanning Brookfield data for selected scavenger blends.

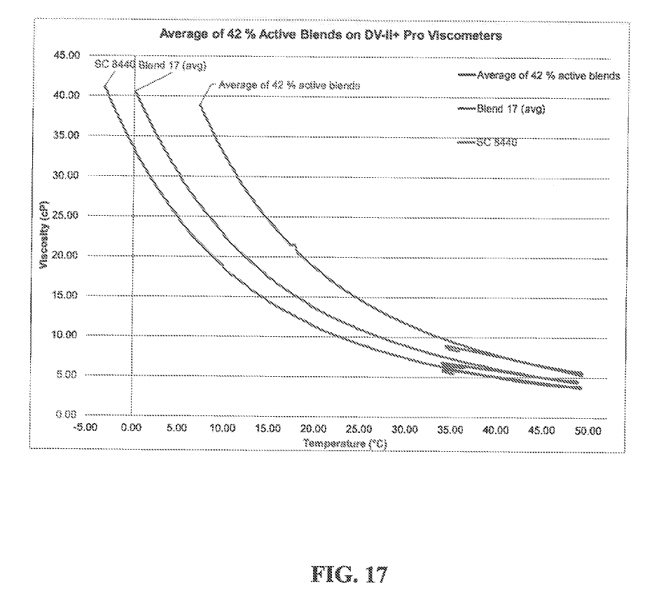

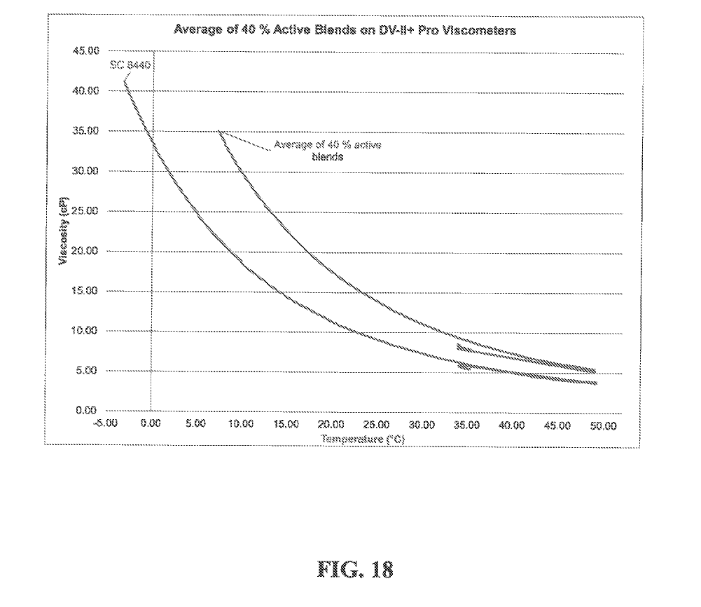

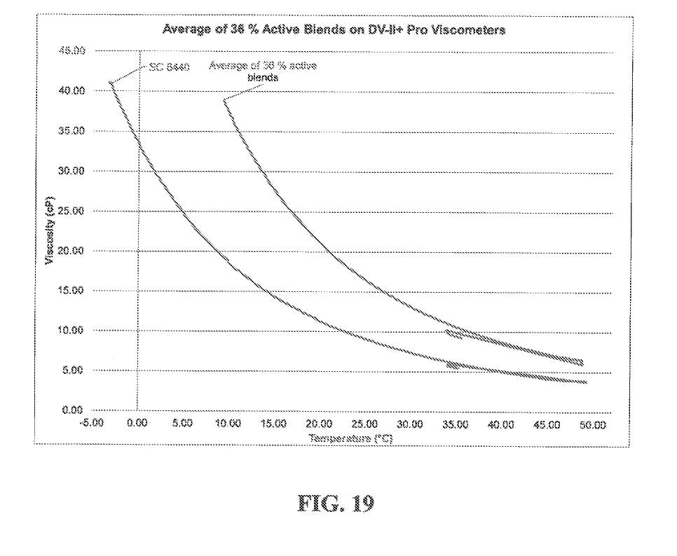

The above graph illustrates that all of the selected blends are of higher viscosity than the chosen standard of SC8440TM. The following three graphs provide a comparison of the average viscosity of selected blends (based on activity) as a function of temperature to the standard of SC8440TM. FIG. 17 also includes Blend 17 (an approximation of the incumbent product) as a point of comparison. As can be seen from the graphs, an inverse relationship exists between the activity and the viscosity of the blends. FIG. 18 shows scanning Brookfield data for selected 40% active scavenger blends. FIG. 19 shows scanning Brookfield data for selected 36% active scavenger blends.

Scavenger Testing

Below is a tabulation of the results of the scavenger testing and a brief description of the observations.

TABLE 13
Scavenger Uptake Data

| | | | Time |
|---|---|---|---|
| | | | to H₂S |
| | Initial | Final | Breakout |
| Blend | Observations | Observations | (min:sec) |
| SC 8440 | Golden | Milky and | 23:50 |
| | yellow, clear | opaque | |
| B3 (42%) | Very light | Light yellow, | 54:33 |
| | yellow, clear | trace cloudiness | |
| B9 (36%) | Light | No noticeable | 48:38 |
| | yellow, clear | changes | |
| B15 (40%) | Very light | Very slightly | 50:28 |
| | yellow, clear | darker yellow | |
| B17 (42%) | Almost | Cloudy | 68:00 |
| | colorless, clear | | |

It was found that SC8440TM became darker and then rapidly became cloudier until becoming milky and opaque in the final 3-4 minutes before H₂S breakout. Blends 3, 9, 15, and 17 showed the above observational properties compared to SC8440TM. Blend 3 and Blend 17 showed slight cloudiness and cloudiness, respectively.

### DISCUSSION

Overall the testing showed that while the various blends are more viscous than SC8440TM, the ones subjected to scavenger testing were at least twice as effective at scavenging H₂S. Blend 17 is an approximation of the current commercial product. The Gly containing Blend 3, 9, and 15 were effective as low evaporation replacement winterizing compositions do not become cloudy or opaque upon being spent.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. A composition comprising: a sulfur scavenger solution including at least one sulfur scavenger, and a winterizing solution including at least one triol.

2. The composition of claim 1, wherein the triol comprises glycerin.

3. (canceled)

4. The composition of claim 1, wherein the winterizing solution further includes an amount of a secondary winterizing agent selected form the group consisting of glycols, alcohols, glymes, glycerols, non-ionic surfactants, dioxolane, and mixtures or combinations thereof, where the amount of each secondary winterizing agent.

5. The composition of claim 1, wherein the sulfur scavenger solution includes triazine sulfur scavengers, non-triazine sulfur scavengers, or mixtures thereof.

6. The composition of claim 5, wherein the triazine sulfur scavenger is a reaction product of an aldehyde with a primary amine.

7. (canceled)

8. (canceled)

9. The composition of claim 5, wherein the sulfur scavenger solution includes from 10 wt. % to 90 wt. % net triazine sulfur scavengers.

10. (canceled)

11. (canceled)

12. A method of reducing noxious sulfur species in a hydrocarbon stream, which comprises contacting the hydrocarbon stream with an effective amount of a sulfur scavenging composition comprising at least one sulfur scavenger and a winterizing solution including in at least one triol, where the winterizing solution lowers a pour point of the triazine sulfur scavenging composition to a temperature of or below −40° C. and reduces an evaporation rate of the triazine sulfur scavenging composition at temperatures between 35° C. and 60° C.

13. The method of claim 12, wherein the hydrocarbon stream comprises at least one hydrocarbon containing steam, produced water containing stream, other downhole stream, or hydrocarbon containing stream transported in a pipeline or flow line.

14. The method of claim 12, wherein the hydrocarbon stream is contacted with the triazine sulfur scavenging composition in a bubble tower or a pipeline.

15. The method of claim 12, wherein the effective amount of the sulfur scavenging composition is determined according to the formula:
X*GP*C_{H2S}
wherein X is a multiplier of from about 0.1 to about 0.5, or 0.2 to about 0.4, or 0.25 to 0.35, or 0.3, GP is the amount of hydrocarbon stream treated in million standard cubic feet per day (MMscfd), and C_{H2S} is the concentration of H₂S in parts per million (ppm).

16. The method of claim 12, wherein the hydrocarbon-containing stream comprises a natural gas containing stream, an crude oil containing stream, a stream including both natural gas and crude oil, a kerosene containing stream, a fuel oil containing stream, a heating oil containing stream, a distillate fuel containing stream, a bunker fuel oil containing stream, or mixtures and combinations thereof.

17. The method of claim 12, wherein the triol comprises glycerin.

18. (canceled)

19. The method of claim 17, wherein the winterizing solution further includes an amount of a secondary winterizing agent selected form the group consisting of glycols, alcohols, glymes, glycerols, non-ionic surfactants, dioxolane, and mixtures or combinations thereof, where the amount of each secondary winterizing agent.

20. The method of claim 12, wherein the sulfur scavenger solution includes triazine sulfur scavengers, non-triazine sulfur scavengers, or mixtures thereof.

21. The method of claim 20, wherein the triazine sulfur scavenger is a reaction product of an aldehyde with a primary amine.

22. (canceled)

23. (canceled)

24. The method of claim 20, wherein the sulfur scavenger solution includes from 10 wt. % to 90 wt. % net triazine sulfur scavengers.

25. (canceled)
